(19) United States
(12) Patent Application Publication
(10) Pub. No.: US 2008/0155678 A1
(43) Pub. Date: Jun. 26, 2008

(54) Computer system for controlling communication to/from terminal

(75) Inventors: Keiko Ohkubo, Tokyo (JP); Morihito Miyagi, Musashino (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/000,138

(22) Filed: Dec. 10, 2007

(30) Foreign Application Priority Data
Dec. 26, 2006 (JP) 2006-349859

(51) Int. Cl. G06F 21/00; H04L 9/00

(52) U.S. Cl. 726/15; 726/14

(57) ABSTRACT

There is provided a computer system comprising a first network and a plurality of second networks. The first network includes an access point, a first communication device, a DHCP server and a first authentication server. Each of the plurality of second networks includes a second terminal device. The first authentication server: identifies which second network is associated with this first terminal device upon reception of an access request from the first terminal device; and send, to the first communication device, access control information that is used to control communication of the second terminal device included in the identified second network. The first communication device controls communication of the first terminal device based on the access control information received from the first authentication server.

### CLAIM OF PRIORITY

The present application claims priority from Japanese patent application JP 2006-349859 filed on Dec. 26, 2006, the content of which is hereby incorporated by reference into this application.

### BACKGROUND OF THE INVENTION

This invention relates to a technique of controlling communication to/from a terminal device that is connected to a network provided by an ISP.

There have been known technologies for terminal device communication control. For example, any other connections than VPN connection are prohibited between a company's intranet and a terminal device by giving the terminal device limited functions. The terminal device has to access the company intranet first in order to access other resources than the company intranet. The company thus ensures that its access policy is applied to communication between the terminal device and a resource that is not the company intranet.

IETF RFC 3748 describes authentication processing that uses Extensible Authentication Protocol-Transport Layer Security (EAP-TLS), which is one of 802.1X authentication sequences.

### SUMMARY OF THE INVENTION

The above-described related art limits communication that the terminal device can have. Therefore the terminal device cannot make full use of the Web when away from the company's office, which lowers the convenience of the terminal device.

Take an international conference as an example, where the terminal device downloads handouts from a server via a wireless Local Area Network (LAN) set up on the site of the conference. The terminal device in this case too has to establish VPN connection with the intranet of the company to which the terminal device belongs, and then a resource of the company intranet obtains the handouts from the server to send the obtained handouts to the terminal device. Obtaining the handouts in this manner can take a long time.

This invention has been made in view of the above-mentioned problems, and it is therefore an object of this invention to provide a computer system that applies an access policy of a company to which a terminal device belongs to communication held by the company's terminal device which is connected to a network provided by an Internet Service Provider (ISP).

A representative aspect of this invention is as follows. That is, there is provided a computer system comprising: a first network connected to the Internet; and a plurality of second networks connected to the Internet. The first network includes an access point which is connected to a first terminal device by radio or cable, a first communication device which is connected to the access point and controls communication of the first terminal device, a DHCP server which allocates an IP address to the first terminal device, and a first authentication server which authenticates the first terminal device. Each of the plurality of second networks includes a second terminal device. The first authentication server: identifies which second network is associated with this first terminal device upon reception of an access request from the first terminal device; and send, to the first communication device, access control information that is used to control communication of the second terminal device included in the identified second network. The first communication device controls communication of the first terminal device based on the access control information received from the first authentication server.

According to the representative mode of this invention, an access policy of a company to which a terminal device belongs can be applied to communication held by the company's terminal which is connected to a network provided by an ISP.

### BRIEF DESCRIPTION OF THE DRAWINGS

The present invention can be appreciated by the description which follows in conjunction with the following figures, wherein:

FIG. 1 is a block diagram showing a configuration of a computer system in accordance with a first embodiment of this invention;

FIG. 2 is a block diagram showing the configuration of the policy enforcer that is provided in the ISP A network in accordance with the first embodiment of this invention;

FIG. 3 is a configuration diagram of the access policy settings table that is contained in the policy enforcer in accordance with the first embodiment of this invention;

FIG. 4 is a block diagram showing the configuration of the AAA server A that is provided in the ISP A network in accordance with the first embodiment of this invention;

FIG. 5 is a configuration diagram of the user data table that is contained in the AAA server A in accordance with the first embodiment of this invention;

FIG. 6 is a configuration diagram of the corporate contract company list that is contained in the AAA server A in accordance with the first embodiment of this invention;

FIG. 7 is a sequence diagram of user access processing in the computer system in accordance with the first embodiment of this invention;

FIG. 8 is a flow chart for packet processing of the policy enforcer in accordance with the first embodiment of this invention;

FIG. 9 is a block diagram showing the configuration of a computer system in accordance with a second embodiment of this invention;

FIG. 10 is a configuration diagram of the corporate contract company list that is contained in the AAA server A in accordance with the second embodiment of this invention;

FIG. 11 is a block diagram showing the configuration of the router Z that is provided in the ISP A network in accordance with the second embodiment of this invention;

FIG. 12 is a configuration diagram of the filtering settings table that is contained in the router Z in accordance with the second embodiment of this invention;

FIG. 13 is a sequence diagram of user access processing in the computer system in accordance with the second embodiment of this invention;

FIG. 14 is a flow chart for authentication processing of the AAA server A in accordance with the second embodiment of this invention;

FIG. 15 is a configuration diagram of the IP address reservation table that is stored in the DHCP server A in accordance with a third embodiment of this invention;

FIG. 16 is a configuration diagram of the filtering settings table 126 that is contained in the router Z 91 in accordance with the third embodiment of this invention;

FIG. 17 is a block diagram showing the configuration of a computer system in accordance with a fourth embodiment of this invention;

FIG. 18 is a configuration diagram of the filtering settings table 126 that is contained in the router Z in accordance with the fourth embodiment of this invention;

FIG. 19 is a configuration diagram of the access policy settings table that is contained in the policy enforcer in accordance with the fourth embodiment of this invention;

FIG. 20 is a sequence diagram of user access processing in the computer system in accordance with the fourth embodiment of this invention;

FIG. 21 is a block diagram showing the configuration of a computer system in accordance with a fifth embodiment of this invention;

FIG. 22 is a configuration diagram of the roaming contract ISP list which is contained in the AAA server A in accordance with the fifth embodiment of this invention;

FIG. 23 is a configuration diagram of the corporate contract company roaming condition list which is contained in the AAA server A in accordance with the fifth embodiment of this invention;

FIG. 24 is a sequence diagram of user access processing in the computer system in accordance with the fifth embodiment of this invention;

FIG. 25 is a flow chart for authentication processing of the AAA server B within the ISP B network in accordance with the fifth embodiment of this invention;

FIG. 26 is a flow chart for authentication processing of the AAA server A according to the ISP A network in accordance with the fifth embodiment of this invention;

FIG. 27 is a sequence diagram of a part of user access processing in the computer system in accordance with a sixth embodiment of this invention;

FIG. 28 is a sequence diagram of a part of user access processing in the computer system in accordance with a seventh embodiment of this invention;

FIG. 29 is a configuration diagram of the user data table that is stored in the AAA server A in accordance with a eighth embodiment of this invention;

FIG. 30 is a sequence diagram showing a part of user access processing that is performed by a computer system in accordance with a ninth embodiment of this invention; and

FIG. 31 is a sequence diagram of authentication processing in the computer system in accordance with a tenth embodiment of this invention.

### DETAILED DESCRIPTION OF THE PREFERRED EMBODIMENTS

Embodiments of this invention will be described with reference to the accompanying drawings.

### First Embodiment

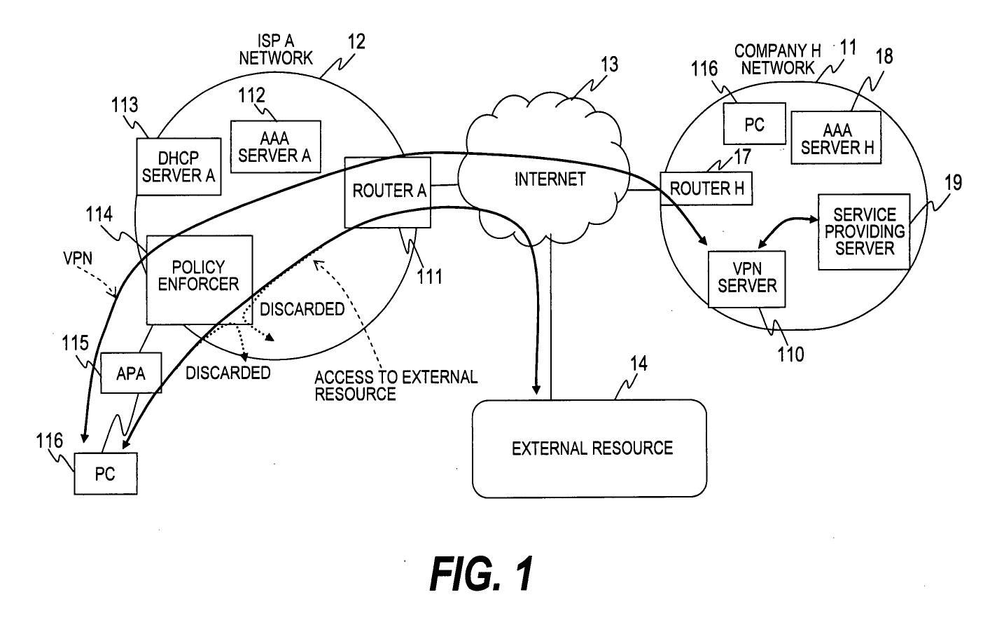

FIG. 1 is a block diagram showing a configuration of a computer system according to a first embodiment of this invention.

The computer system has a company H network 11, an Internet Service Provider (ISP) A network 12, the Internet 13, and an external resource 14.

The ISP A network 12 is a network provided by an Internet service provider “A”. An ISP is a business entity that provides an Internet connection service to a user terminal (user PC) 116. The term ISP also includes public wireless LAN service providers (Wireless ISPs: W-ISPs).

The ISP A network 12 is connected to at least one AP A 115. The AP A 115 is an access point (AP) connected to the user PC 116 by cable or radio. The user PC 116 is a computer having a CPU, a memory, and an interface, and operated by a user.

The ISP A network 12 has a policy enforcer 114, a DHCP server A 113, an Authentication Authorization Accounting (AAA) server A 112, and a router A 111. FIG. 1 shows one policy enforcer 114, DHCP server A 113, AAA server A 112, and router A 111, but the ISP A network 12 may have two or more of each of these components.

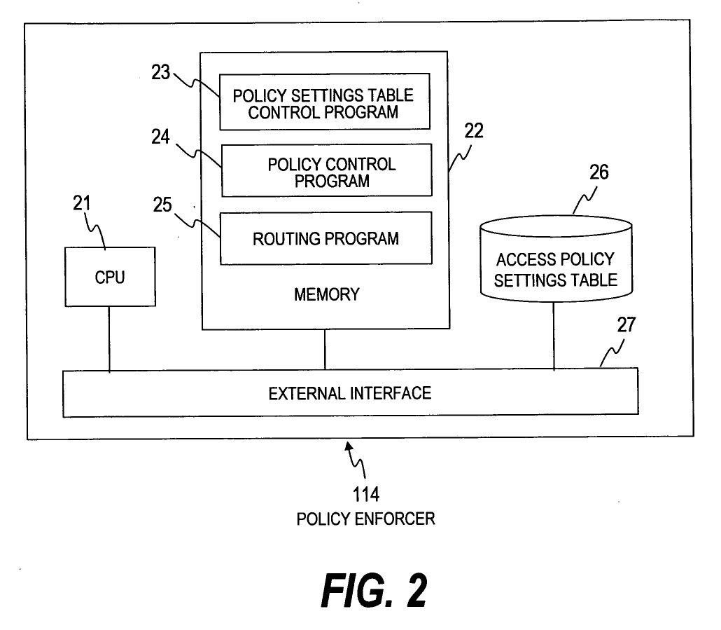

The policy enforcer 114 controls communication to/from the user PC 116 in accordance with an access policy. Details of the policy enforcer 114 will be described with reference to FIG. 2.

The DHCP server A 113 is a computer having a CPU, a memory, and an interface. The DHCP server A 113 automatically allocates necessary information which includes an IP address, among others, to the user PC 116.

The AAA server A 112 performs authentication on the user PC 116. Details of the AAA server A 112 will be described with reference to FIG. 4.

The router A 111 is connected to the Internet 13. The router A 111 receives packets and transfers the received packets.

The company H network 11 is an intranet set up within a company “H”. The company H network 11 has a router H 17, a Virtual Private Network (VPN) server 110, an AAA server H 18, another user PC 116, and a service providing server 19.

The router H 17 is connected to the Internet 13. The router H 17 receives packets and transfers the received packets.

The AAA server H 18 is a computer having a CPU, a memory, and an interface. The AAA server H 18 performs authentication on the user PC 116. The AAA server H 18 also manages access policies applied to communication that is held by the user PC 116.

The VPN server 110 is a computer having a CPU, a memory, and an interface. The VPN server 110 switches packet headers and encrypts packets. The VPN server 110 thus provides connection that utilizes a VPN.

The user PC 116 is a computer having a CPU, a memory, and an interface, and operated by a user. For example, the user PC 116 is a mobile computer. The user PC 116 within the company H network 11 may be carried around by the user to be connected to the AP A 115. In this embodiment, the same access policy is applied to user PC communication even when the user PC 116 is connected to the AP A 115 or is within the company H network 11.

The service providing server 19 is a computer having a CPU, a memory, and an interface. The service providing server 19 provides various application programs to the user PC 116. For example, the service providing server 19 is a Web server or a mail server.

The external resource 14 is a computer having a processor, a memory, and an interface. The external resource 14 provides a Web service to the user PC 116.

FIG. 2 is a block diagram showing the configuration of the policy enforcer 114 that is provided in the ISP A network 12 according to the first embodiment of this invention.

The policy enforcer 114 has a CPU 21, a memory 22, an access policy settings table 26, and an external interface 27.

The external interface 27 is an interface connected to an external device. The external interface 27 is connected to, for example, the AP A 115, the DHCP server A 113, the AAA server A 112, and the router A 111.

The CPU 21 executes various types of processing by running programs that are stored in the memory 22. The memory 22 stores programs run by the CPU 21, information needed by the CPU 21, and the like. Specifically, the memory 22 stores a policy settings table control program 23, a policy control program 24, and a routing program 25.

The policy settings table control program 23 updates the access policy settings table 26. The policy control program 24 applies an access policy to communication held by the user PC 116.

The routing program 25 receives packets and transfers the received packets.

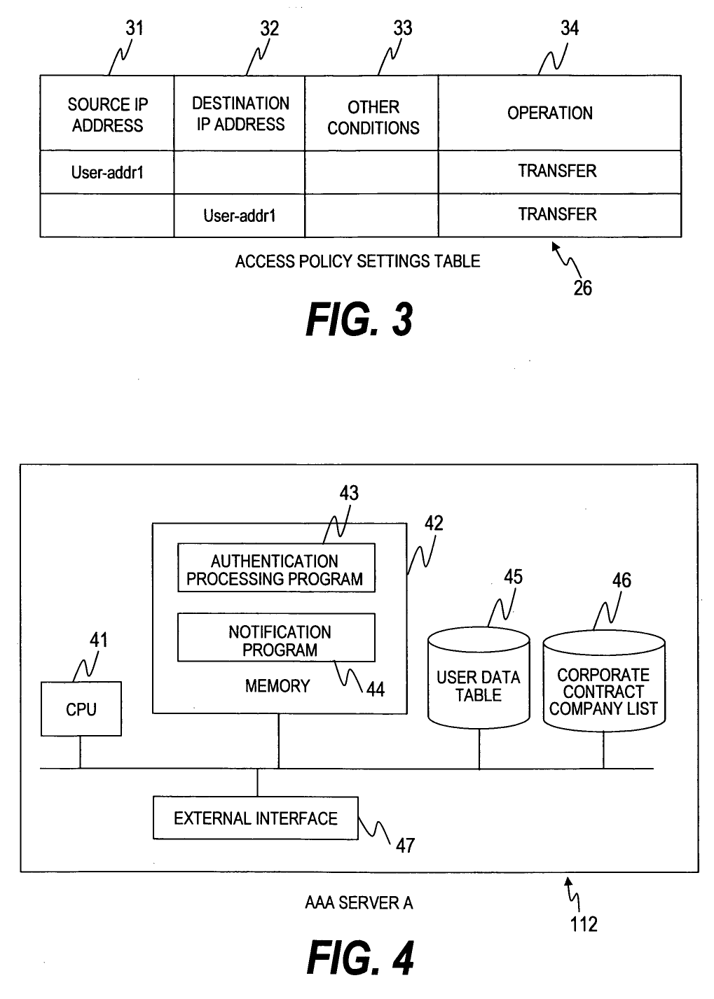

The access policy settings table 26 is used to manage access policies applied to communication of the user PC 116. Details of the access policy settings table 26 will be described with reference to FIG. 3.

FIG. 3 is a configuration diagram of the access policy settings table 26 that is contained in the policy enforcer 114 according to the first embodiment of this invention.

Each record in the access policy settings table 26 shows one access policy, and contains a source IP address 31, a destination IP address 32, other conditions 33, and an operation 34.

The source IP address 31 indicates the IP address of the source terminal of a packet to which an access policy shown by the record in question is applied. The destination IP address 32 indicates the IP address of the destination of a packet to which an access policy shown by the record in question is applied.

The other conditions 33 indicate conditions of a packet to which an access policy shown by the record in question is applied. For example, at least one of the protocol type, destination URL, source URL, source port number, and destination port number of a packet to which an access policy shown by the record in question is applied is stored as the other conditions 33.

The operation 34 indicates specifics of an access policy shown by the record in question. For example, “transfer” or “discard” is stored as the operation 34.

FIG. 4 is a block diagram showing the configuration of the AAA server A 112 that is provided in the ISP A network 12 according to the first embodiment of this invention.

The AAA server A 112 has a CPU 41, a memory 42, a user data table 45, a corporate contract company list 46, and an external interface 47.

The external interface 47 is an interface connected to an external device. The external interface 47 is connected to, for example, the policy enforcer 114, the DHCP server A 113, and the router A 111.

The CPU 41 executes various types of processing by running programs that are stored in the memory 42. The memory 42 stores programs run by the CPU 41, information needed by the CPU 41, and the like. Specifically, the memory 42 stores an authentication processing program 43 and a notification program 44.

The authentication processing program 43 performs authentication on the user PC 116. The notification program 44 notifies various kinds of information to the policy enforcer 114, the DHCP server A 113, the router A 111, and other components.

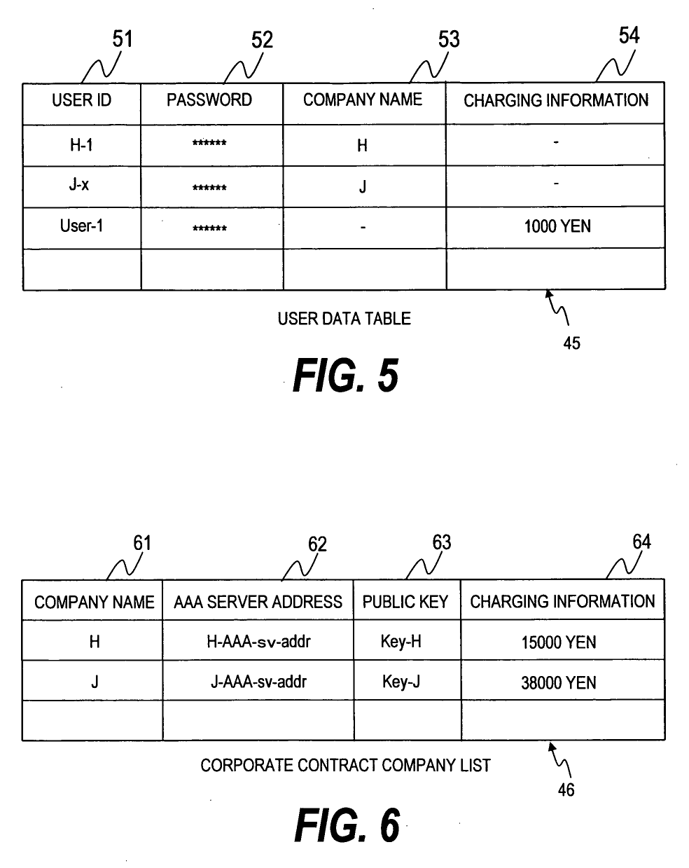

The user data table 45 is used to manage information related to users of the ISP “A”. Details of the user data table 45 will be described with reference to FIG. 5. The corporate contract company list 46 is used to manage information related to companies that have a corporate contract with the ISP “A”. Details of the corporate contract company list 46 will be described with reference to FIG. 6.

FIG. 5 is a configuration diagram of the user data table 45 that is contained in the AAA server A 112 according to the first embodiment of this invention.

The user data table 45 contains in each record entry a user ID 51, a password 52, a company name 53, and charging information 54.

The user ID 51 indicates an identifier unique to each user of the ISP “A”. The password 52 indicates a password set to a user who is identified by the user ID 51 of the record in question. The company name 53 indicates an identifier unique to a company to which a user identified by the user ID 51 of the record in question belongs. The charging information 54 indicates the amount of money charged to a user who is identified by the user ID 51 of the record in question.

FIG. 6 is a configuration diagram of the corporate contract company list 46 that is contained in the AAA server A 112 according to the first embodiment of this invention.

The corporate contract company list 46 contains in each record entry a company name 61, an AAA server address 62, a public key 63, and charging information 64.

The company name 61 indicates an identifier unique to each company that has a corporate contract with the ISP “A”. The AAA server address 62 indicates the IP address of the AAA server H 18 within the intranet of a company that is identified by the company name 61 of the record in question. The public key 63 indicates the public key of the AAA server H 18 within the intranet of a company that is identified by the company name 61 of the record in question. The charging information 64 indicates the amount of money charged to a company that is identified by the company name 61 of the record in question.

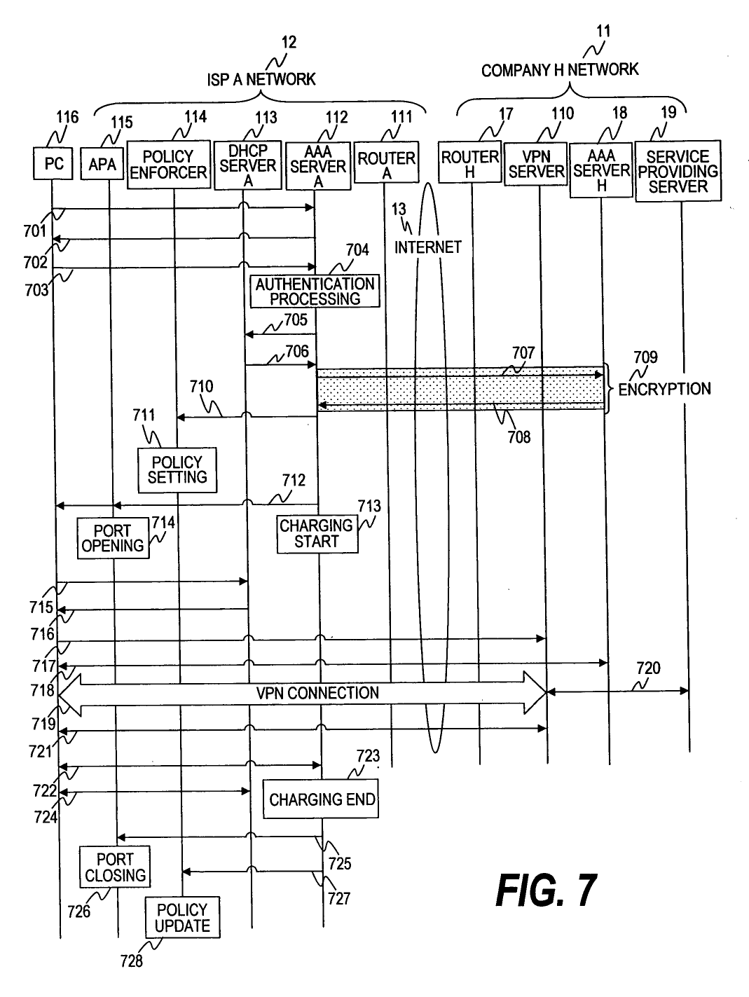

FIG. 7 is a sequence diagram of user access processing in the computer system according to the first embodiment of this invention.

This sequence diagram illustrates a case where the user PC 116 is successfully authenticated.

The company “H” has a corporate contract with the ISP “A”. The user data table 45 in the AAA server A 112 therefore holds information related to a user who belongs to the company “H”, and the corporate contract company list 46 in the AAA server A 112 holds information related to the company “H”.

First, the user PC 116 sends an access request to the AAA server A 112 via the AP A 115 and the policy enforcer 114 (701). The AAA server A 112 receives the access request. The AAA server A 112 then sends an authentication information request via the policy enforcer 114 and the AP A 115 to the user PC 116 that has sent the access request (702).

The user PC 116 receives the authentication information request. The user PC 116 then sends authentication information containing a user ID and a password to the AAA server A 112 via the AP A 115 and the policy enforcer 114 (703).

The AAA server A 112 receives the authentication information containing a user ID and a password. At this point, the AAA server A 112 obtains the MAC address of the user PC 116. The AAA server A 112 next chooses from the user data table 45 a record whose user ID 51 of the user data table 45 matches the received user ID. From the chosen record, the AAA server A 112 extracts the password 52 and the company name 53.

The AAA server A 112 next performs authentication on the user PC 116 by judging whether or not the received password matches the extracted password 52 (704).

When the received password does not match the extracted password 52, the AAA server A 112 judges that the user PC 116 has failed in passing authentication. Then the AAA server A 112 notifies the AP A 115 and the user PC 116 of the authentication failure.

When the received password matches the extracted password 52, on the other hand, the AAA server A 112 judges that the user PC 116 has successfully been authenticated. Then the AAA server A 112 judges whether or not the extracted company name 53 holds a value.

When the extracted company name 53 does not hold a value, it means that a user identified by the received user ID is not a corporate user. The AAA server A 112 accordingly notifies the AP A 115 and the user PC 116 of the authentication success.

When the extracted company name 53 holds a value, it means that a company to which a user identified by the received user ID belongs has a corporate contract with the ISP “A”. Then the AAA server A 112 sends the obtained MAC address of the user PC 116 to the DHCP server A 113 (705).

The DHCP server A 113 receives the MAC address. The DHCP server A 113 then sends to the AAA serve A 112 an IP address to be allocated to the user PC 116 that has the received MAC address (706). The DHCP server A 113 also stores the association between the received MAC address and the IP address to be allocated.

The AAA server A 112 receives the IP address to be allocated to the user PC 116. The AAA server A 112 then chooses from the corporate contract company list 46 a record whose company name 61 of the corporate contract company list 46 matches the extracted company name 53. From the chosen record, the AAA server A 112 extracts the AAA server address 62 and the public key 63.

The AAA server A 112 sends an access policy request to the extracted AAA server address 62. The AAA server A 112 thus sends an access policy request to the AAA server H 18, which is within the company H network 11 (707).

The AAA server H 18 receives the access policy request. The AAA server H 18 then sends an access policy that is applied to communication of the user PC 116 to the AAA server A 112 within the ISP A network 12 (708).

Setting of an access policy may be on a user basis or on a company basis. In the case where setting of an access policy is on a user basis, the access policy request contains a user ID, and the AAA server H 18 sends to the AAA server A 112 an access policy that is associated with the user ID contained in the received access policy request (708).

The access policy request, as well as the access policy sent in response, must be transmitted and received securely. For instance, the AAA server A 112 and the AAA server H 18 encrypt the access policy request and the access policy by a public key cryptosystem before exchanging the request and the policy (709).

Specifically, the AAA server A 112 encrypts the access policy request using the extracted public key 63. The AAA server A 112 sends the encrypted access policy request to the AAA server H 18. The AAA server H 18 receives the encrypted access policy request. The AAA server H 18 decrypts the received access policy request using a private key that is assigned to this AAA server H 18.

The AAA server H 18 uses a public key of the AAA server A 112 to encrypt an access policy that is to be applied to communication held by the user PC 116. The AAA server H 18 sends the encrypted access policy to the AAA server A 112. The AAA server A 112 receives the encrypted access policy. The AAA server A 112 decrypts the received access policy using a private key that is assigned to this AAA server A 112.

The AAA server A 112 and the AAA server H 18 may use a secret cryptosystem instead of a public key cryptosystem in encrypting the access policy request and the access policy before exchanging the request and the policy.

Receiving the access policy to be applied to communication of the user PC 116, the AAA server A 112 sends the received access policy and the IP address received in Step 706 to the policy enforcer 114 (710).

The policy enforcer 114 receives the access policy and the IP address. Using the received access policy and IP address, the policy enforcer 114 updates the access policy settings table 26 (711).

For example, the policy enforcer 114 creates two new records in the access policy settings table 26. The policy enforcer 114 stores the received IP address as the source IP address 31 in one of the created records. In the other created record, the policy enforcer 114 stores the received IP address as the destination IP address 32. The policy enforcer 114 then stores processing specifics associated with the received access policy as the operation 34 in the created two records.

Meanwhile, the AAA server A 112 notifies the AP A 115 and the user PC 116 of the authentication success (712). In the case of metered billing, the AAA server A 112 starts collecting information necessary for charging (713).

The AP A 115 receives the authentication success notification. The AP A 115 then opens a port for the user PC 116 (714).

The user PC 116 receives the authentication success notification. The user PC 116 then sends an IP address allocation request to the DHCP server A 113 (715).

Receiving the IP address allocation request, the DHCP server A 113 obtains the MAC address of the user PC 116 that has sent the IP address allocation request. The DHCP server A 113 next identifies which IP address is to be allocated to the user PC 116 that has the obtained MAC address. The DHCP server A 113 then allocates the identified IP address to the user PC 116 (716).

This enables the user PC 116 to connect to the Internet 13.

The description given here is related to a case in which the user PC 116 subsequently attempts to establish VPN connection.

The user PC 116 sends an access request to the VPN server 110, which is within the company H network 11 (717). Thereafter, the AAA server H 18 within the company H network 11 performs authentication processing on the user PC 116 (718).

When the user PC 116 fails in passing authentication, the AAA server H 18 notifies the user PC 116 of the authentication failure. Then the user PC 116 cannot access the company H network 11.

When the user PC 116 is successfully authenticated, a VPN tunnel is built between the user PC 116 and the VPN server 110 (719). Using the built VPN tunnel, the user PC 116 accesses the service providing server 19 (720).

When the VPN communication session is finished, the user PC 116 executes de-connect processing to de-connect from the VPN server 110 (721). The user PC 116 next executes de-connect processing to de-connect from the AAA server A 112 (722).

In the case of metered billing, the AAA server A 112 stops collecting information necessary for charging (723).

Next, the DHCP server A 113 frees up the IP address that has been allocated to the user PC 116 (724). The AAA server A 112 notifies the AP A 115 and the policy enforcer 114 of the end of the communication session held by the user PC 116 (725 and 727).

Notified of the end of the communication of the user PC 116, the AP A 115 closes the port for this user PC 116 (726).

The policy enforcer 114, upon reception of the notification of the end of the communication of the user PC 116, updates the access policy settings table 26 (728).

Specifically, the policy enforcer 114 deletes from the access policy settings table 26 a record whose source IP address 31 of the access policy settings table 26 matches the IP address allocated to the user PC 116 that is about to end the communication session. The policy enforcer 114 then deletes from the access policy settings table 26 a record whose destination IP address 32 of the access policy settings table 26 matches the IP address allocated to the user PC 116 that is about to end the communication session.

The computer system then ends the user access processing.

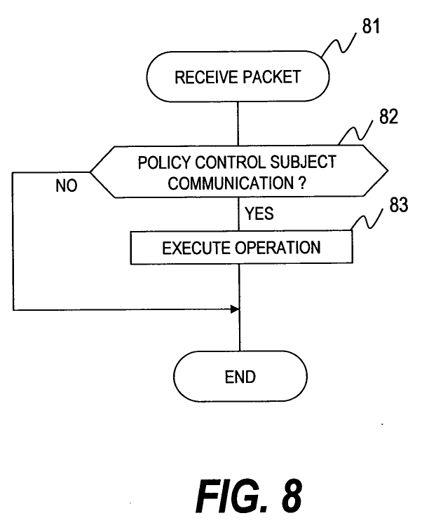

FIG. 8 is a flow chart for packet processing of the policy enforcer 114 according to the first embodiment of this invention.

The policy enforcer 114 receives a packet (81) and starts the packet processing.

First, the policy enforcer 114 judges whether or not the received packet is to be controlled under an access policy (82). Specifically, the policy enforcer 114 selects from the access policy settings table 26 a record whose source IP address 31 of the access policy settings table 26 matches the source IP address of the received IP packet. A record of the access policy settings table 26 that holds no value as the source IP address 31 is also chosen by the policy enforcer 114 as a record whose source IP address 31 of the access policy settings table 26 matches the source IP address of the received packet.

From among the selected records of the access policy settings table 26, the policy enforcer 114 selects a record that whose destination IP address 32 of the access policy settings table 26 matches an IP address to which the received IP address is to be sent. A record of the access policy settings table 26 that holds no value as the destination IP address 32 is also chosen by the policy enforcer 114 as a record whose destination IP address 32 of the access policy settings table 26 matches the destination IP address of the received packet.

The policy enforcer 114 next chooses from among the selected records of the access policy settings table 26 a record whose other conditions 33 of the access policy settings table 26 are met by the received packet. The policy enforcer 114 judges whether or not such a record has successfully been chosen.

When there is no record that meets the conditions, the policy enforcer 114 judges that the received packet is not to be controlled under an access policy. Then the policy enforcer 114 transfers the received packet, and ends the packet processing.

When there is a record that meets the conditions, the policy enforcer 114 judges that the received packet is to be controlled under an access policy. Then the policy enforcer 114 extracts the operation 34 from the chosen record. The policy enforcer 114 next performs processing that is indicated by the extracted operation 34 on the received packet (83).

In the case where “transfer” is stored as the operation 34, for example, the policy enforcer 114 transfers the received packet. In the case where “discard” is stored as the operation 34, the policy enforcer 114 discards the received packet.

The policy enforcer 114 then ends the packet processing.

In the manner described above, the policy enforcer 114 sorts packets sent from the user PC 116 and packets destined to the user PC 116 into ones that satisfy access policies and ones that do not, and transfers only the former packets. The policy enforcer 114 also makes it possible to apply an access policy applied to communication of the user PC 116 that is within the company H network 11 on communication of the user PC 116 that is connected to the AP A 115.

According to this embodiment, an access policy of a company that has a corporate contract with an ISP can be applied to communication held by the user PC 116 that belongs to the company. Further, the proportion of VPN connection held by the user PC 116 and the company's network can be reduced because the ISP exerts access policy control.

### Second Embodiment

The user PC 116 in a second embodiment of this invention is allowed to have no other connections than VPN connection.

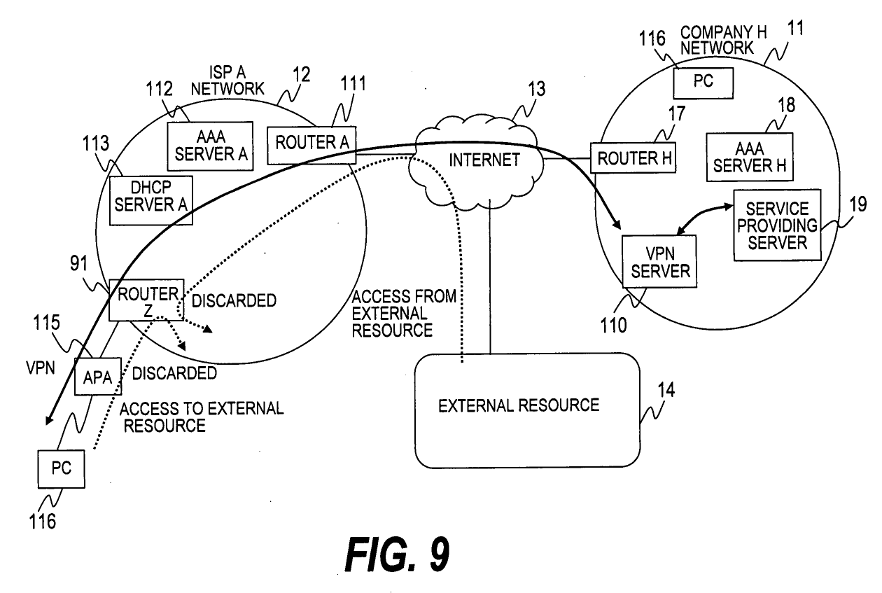

FIG. 9 is a block diagram showing the configuration of a computer system according to the second embodiment of this invention.

The computer system has a company H network 11, an ISP A network 12, the Internet 13, and an external resource 14.

The company H network 11, the Internet 13, and the external resource 14 in the computer system of the second embodiment are the same as those in the computer system of the first embodiment. The company H network 11 in the computer system of the second embodiment is the same as the one in the computer system of the first embodiment except that the policy enforcer 114 is replaced by a router Z 91. Components common to the first and second embodiments are denoted by the same reference symbols in order to avoid repetitive description.

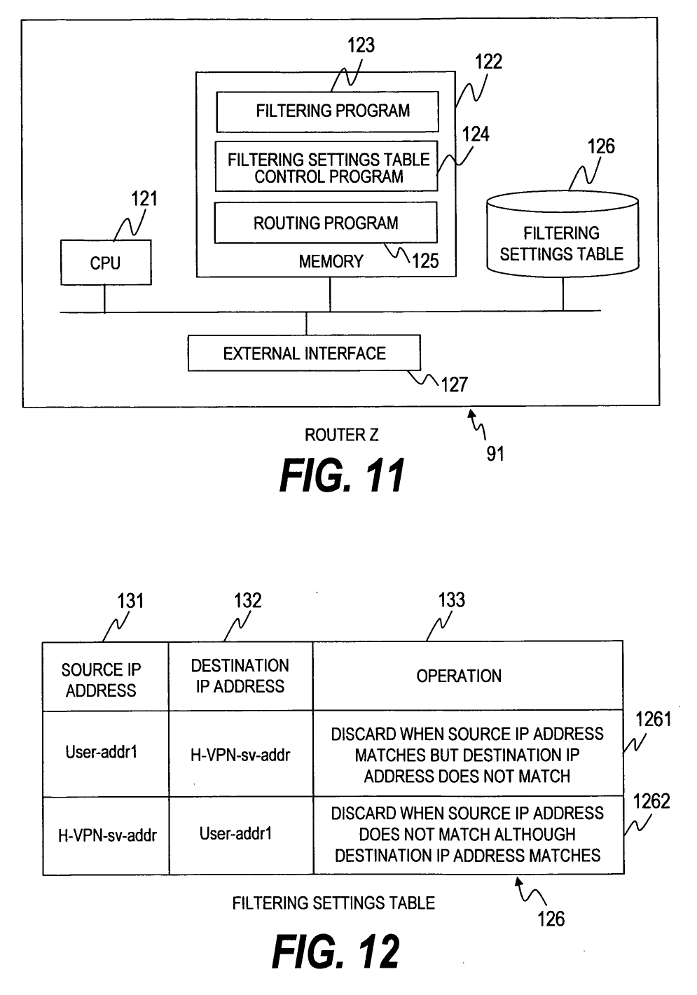

The router Z 91 is connected to the AP A 115. The router Z 91 receives packets and transfers the received packets. The router Z 91 also controls communication of the user PC 116 in accordance with an access policy. Details of the router Z 91 will be described with reference to FIG. 11.

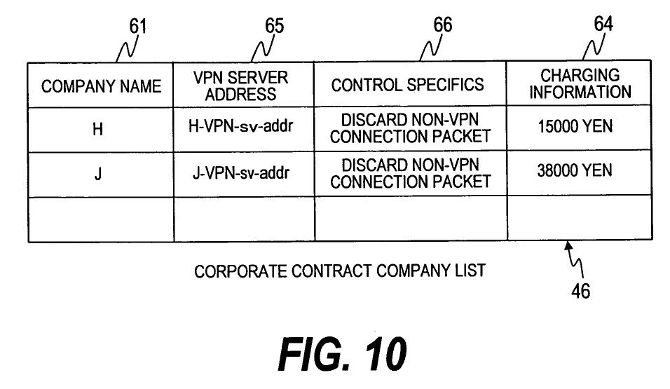

FIG. 10 is a configuration diagram of the corporate contract company list 46 that is contained in the AAA server A 112 according to the second embodiment of this invention.

The corporate contract company list 46 contains in each record entry a company name 61, a VPN server address 65, a control specifics, and charging information 64.

The company name 61 indicates an identifier unique to each company that has a corporate contract with the ISP “A”. The VPN server address 65 indicates the IP address of the VPN server 110 within the intranet of a company that is identified by the company name 61 of the record in question. The control specifics 66 indicate what control is exerted on communication of the user PC 116 belonging to a company that is identified by the company name 61 of the record in question. Because the user PC 116 in this embodiment is allowed to have only VPN connection, the control specifics 66 indicate discard of any other packets than the ones for VPN connection.

The charging information 64 indicates the amount of money charged to a company that is identified by the company name 61 of the record in question.

FIG. 11 is a block diagram showing the configuration of the router Z 91 that is provided in the ISP A network 12 according to the second embodiment of this invention.

The router Z 91 has a CPU 121, a memory 122, a filtering settings table 126, and an external interface 127.

The external interface 127 is an interface connected to an external device. The external interface 127 is connected to, for example, the AP A 115, the DHCP server A 113, the AAA server A 112, and the router A 111.

The CPU 121 executes various types of processing by running programs that are stored in the memory 122. The memory 122 stores programs run by the CPU 121, information needed by the CPU 121, and the like. Specifically, the memory 122 stores a filtering program 123, a filtering settings table 126 control program 124, and a routing program 125.

The filtering program 123 filters received packets by referring to the filtering settings table 126. The filtering settings table control program 124 updates the filtering settings table 126. The routing program 125 receives packets and transfers the received packets.

The filtering settings table 126 shows information related to packets to be filtered. Details of the filtering settings table 126 will be described with reference to FIG. 12.

FIG. 12 is a configuration diagram of the filtering settings table 126 that is contained in the router Z 91 according to the second embodiment of this invention.

The filtering settings table 126 contains a source IP address 131, a destination IP address 132, and an operation 133.

The source IP address 131 and the destination IP address 132 are conditions for determining whether to execute the operation 133 of the record in question for a packet. The operation 133 indicates how a packet that meets the description of the record in question is to be processed.

To give an example, a record 1261 holds as the source IP address 131 an IP address allocated to the user PC 116. As the destination IP address 132, the record 1261 holds the IP address of the VPN server 110 within the company H network 11. The operation 133 of the record 1261 indicates discard of a packet that meets the description of the record 1261. The router Z 91 accordingly picks up packets that are not destined to the VPN server 110 from among packets sent from the user PC 116, and discards the picked up packets.

A record 1262 holds as the source IP address 131 the IP address of the VPN server 110 within the company H network 11. As the destination IP address 132, the record 1262 holds an IP address allocated to the user PC 116. The operation 133 of the record 1262 indicates discard of a packet that meets the description of the record 1262. The router Z 91 accordingly picks up packets that are not sent from the VPN server 110 from among packets destined to the user PC 116, and discards the picked up packets.

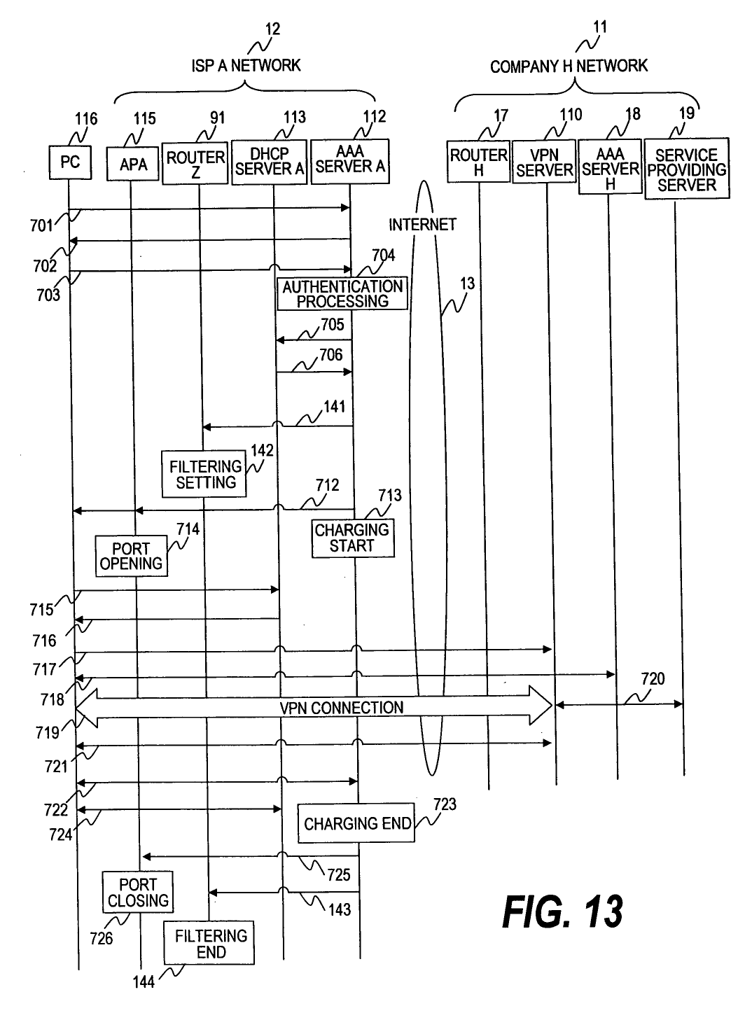

FIG. 13 is a sequence diagram of user access processing in the computer system according to the second embodiment of this invention.

This sequence diagram illustrates a case where the user PC 116 is successfully authenticated.

The company “H” has a corporate contract with the ISP “A”. The user data table 45 in the AAA server A 112 therefore holds information related to a user who belongs to the company “H”, and the corporate contract company list 46 in the AAA server A 112 holds information related to the company “H”.

Steps 701 to 706 are executed first. Steps 701 to 706 in the user access processing of the second embodiment are the same as those in the user access processing performed by the computer system of the first embodiment in the manner shown in FIG. 7, and the description will not be repeated.

When Step 706 is finished, the AAA server A 112 then chooses from the corporate contract company list 46 a record whose company name 61 of the corporate contract company list 46 matches the company name 53 extracted in Step 704. From the chosen record, the AAA server A 112 extracts the VPN server address 65 and the control specifics 66.

The AAA server A 112 next sends the extracted VPN server address 65, the extracted control specifics 66, and the IP address received in Step 706 to the router Z 91 (141).

The router Z 91 receives the VPN server address 65, the control specifics 66, and the IP address. Using the received VPN server address 65, control specifics 66, and IP address, the router Z 91 updates the filtering settings table 126 (142).

For example, the router Z 91 creates a new record in the filtering settings table 126. In the newly created record, the router Z 91 stores the received VPN server address 65 as the source IP address 131. The router Z 91 stores the received IP address as the destination IP address 132 in the newly created record. As the operation 133, the router Z 91 stores the received control specifics 66 in the newly created record.

The router Z 91 creates another new record in the filtering settings table 126. In the newly created record, the router Z 91 stores the received IP address as the source IP address 131. The router Z 91 stores the received VPN server address 65 as the destination IP address 132 in the newly created record. As the operation 133, the router Z 91 stores the received control specifics 66 in the newly created record.

Thereafter, the router Z 91 conducts filtering based on the updated filtering settings table 126. The router Z 91 accomplishes the filtering by cutting connection between the user PC 116 and the external resource 14 out of other connections of the user PC 116 belonging to a company that has a corporate contract. In other words, the router Z 91 allows only VPN connection out of connections of the user PC 116 belonging to a company that has a corporate contract.

Steps 712 to 726 are subsequently executed. Steps 712 to 726 in the user access processing of the second embodiment are the same as those in the user access processing performed by the computer system of the first embodiment, and the description will not be repeated.

When Step 726 is finished, the AAA server A 112 notifies the router Z 91 of the end of the communication session held by the user PC 116 (143).

Notified of the end of communication of the user PC 116, the router Z 91 updates the filtering settings table 126. The router Z 91 then ends the filtering (144).

Specifically, the router Z 91 deletes from the filtering settings table 126 a record whose source IP address 131 of the filtering settings table 126 matches the IP address allocated to the user PC 116 that is about to end the communication session. The router Z 91 then deletes from the access policy settings table 126 a record whose destination IP address 132 of the filtering settings table 126 matches the IP address allocated to the user PC 116 that is about to end the communication session.

The computer system then ends the user access processing.

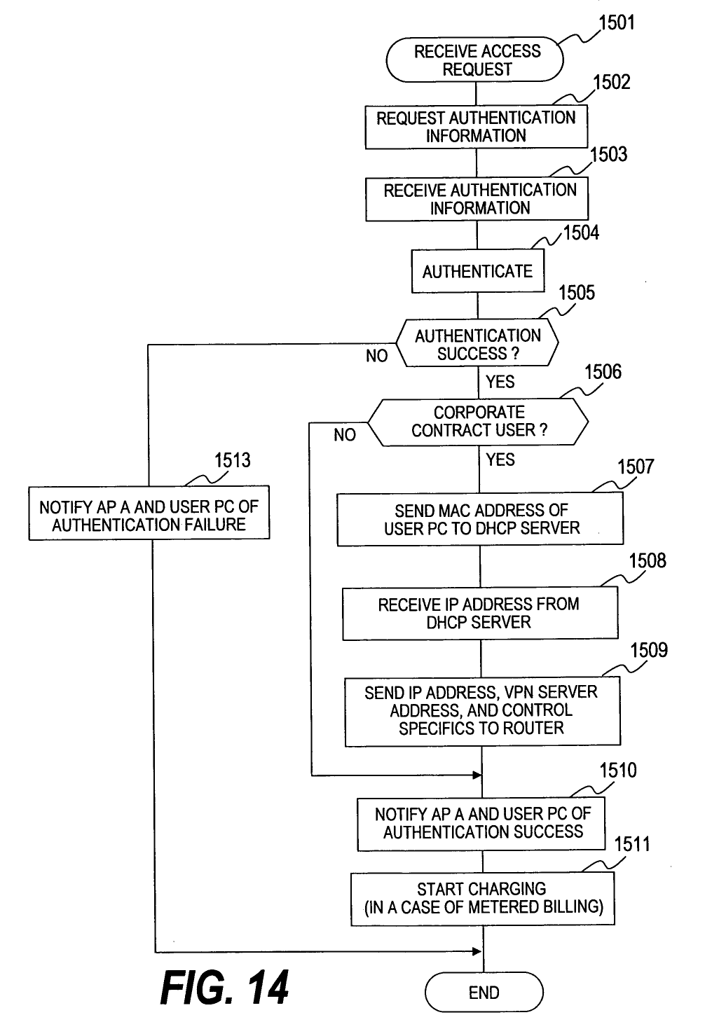

FIG. 14 is a flow chart for authentication processing of the AAA server A 112 according to the second embodiment of this invention.

The AAA server A 112 receives an access request from the user PC 116 (1501), and starts this authentication processing.

First, the AAA server A 112 sends an authentication information request to the user PC 116 that has sent the access request (1502). Receiving the authentication information request, the user PC 116 sends authentication information which contains a user ID and a password.

The AAA server A 112 receives the authentication information containing a user ID and a password (1503). At this point, the AAA server A 112 obtains the MAC address of the user PC 116.

The AAA server A 112 next chooses from the user data table 45 a record whose user ID 51 of the user data table 45 matches the received user ID. From the chosen record, the AAA server A 112 extracts the password 52 and the company name 53.

The AAA server A 112 next performs authentication on the user PC 116 by judging whether or not the received password matches the extracted password 52 (1504).

When the received password does not match the extracted password 52, the AAA server A 112 judges that the user PC 116 has failed in passing authentication (1505). Then the AAA server A 112 notifies the AP A 115 and the user PC 116 of the authentication failure (1513).

When the received password matches the extracted password 52, on the other hand, the AAA server A 112 judges that the user PC 116 has successfully been authenticated (1505). Then the AAA server A 112 judges whether or not the extracted company name 53 holds a value. The AAA server A 112 thus judges whether or not a company to which a user identified by the received user ID belongs has a corporate contract with the ISP “A” (1506).

When the extracted company name 53 holds no value, it means that a company to which a user identified by the received user ID belongs does not have a corporate contract with the ISP “A”. Then the AAA server A 112 proceeds directly to Step 1510, where the AAA server A 112 notifies the AP A 115 and the user PC 116 of the authentication success.

When the extracted company name 53 holds a value, it means that a company to which a user identified by the received user ID belongs has a corporate contract with the ISP “A”. Then the AAA server A 112 sends the obtained MAC address of the user PC 116 to the DHCP server A 113 (1507).

The AAA server A 112 receives the IP address to be allocated to the user PC 116 from DHCP server A 113 (1508). The AAA server A 112 then chooses from the corporate contract company list 46 a record whose company name 61 of the corporate contract company list 46 matches the extracted company name 53. From the chosen record, the AAA server A 112 extracts the VPN server address 5 and the control specifics 66.

The AAA server A 112 sends the extracted VPN server address 65, the extracted control specifics 66, and the received IP address to the router Z 91 (1509).

The AAA server A 112 subsequently notifies the AP A 115 and the user PC 116 of the authentication success (1510). In the case of metered billing, the AAA server A 112 also starts collecting information necessary for charging (1511).

The AAA server A 112 then ends the authentication processing.

In this embodiment, an access policy of a company is registered in advance as the control specifics 66 of the corporate contract company list 46, which is contained in the AAA server A 112, but advance registration is not always necessary. In the case where an access policy is not registered in advance, the AAA server A 112 obtains the access policy from the AAA server H 18 of the company H network 11 as in the first embodiment.

Setting of an access policy in this embodiment is on a company basis, but instead may be on a user basis. In this case, an access policy is registered in the user data table 45 contained in the AAA server A 112.

### Third Embodiment

In a third embodiment of this invention, an IP address to be allocated to the user PC 116 is fixed in advance for each company that has a corporate contract with the ISP “A”.

A computer system according to the third embodiment of this invention has the same configuration as the computer system described in the second embodiment with reference to FIG. 9, and its description will be omitted here. However, the computer system of the third embodiment differs from the computer system of the second embodiment in that the DHCP server A 113 has an IP address reservation table 161, which is used to manage IP addresses allocated to the user PC 116 that belongs to a company.

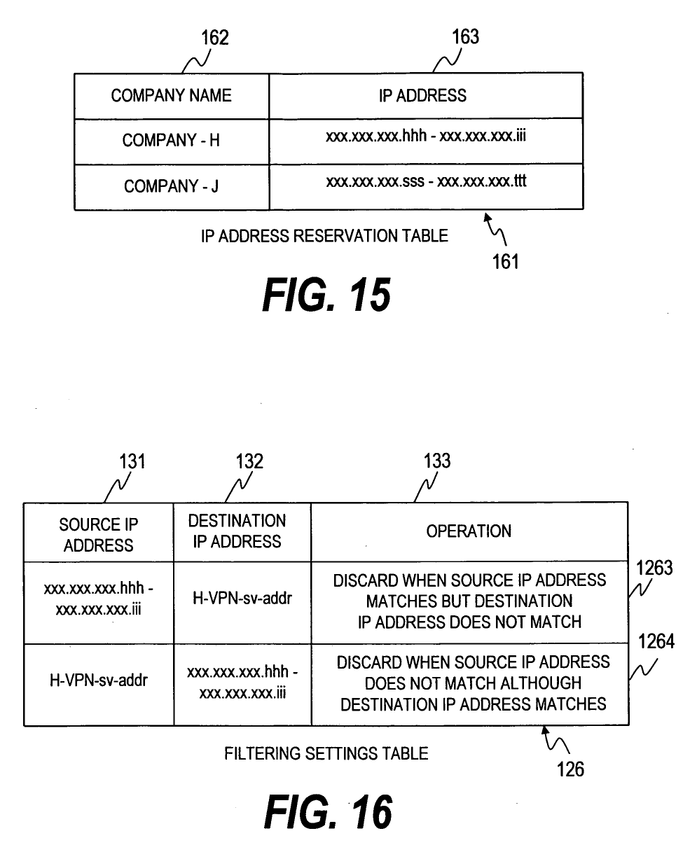

FIG. 15 is a configuration diagram of the IP address reservation table 161 that is stored in the DHCP server A 113 according to the third embodiment of this invention.

The IP address reservation table 161 contains in each record entry a company name 162, and IP address 163.

The company name 162 indicates an identifier unique to each company that has a corporate contract with the ISP “A”. The IP address 163 indicates an IP address allocated to the user PC 116 belonging to a company that is identified by the company name 162 of the record in question.

The DHCP server A 113 receives an IP address allocation request from the user PC 116, and meets the request by allocating to the user PC 116 an IP address that is assigned to a company to which this user PC 116 belongs.

In this embodiment, an IP address allocated to the user PC 116 is thus fixed in advance for each company that has a corporate contract with the ISP “A”. Accordingly, information may be registered in advance in the filtering settings table 126, which is contained in the router Z 91.

FIG. 16 is a configuration diagram of the filtering settings table 126 that is contained in the router Z 91 according to the third embodiment of this invention.

The filtering settings table 126 contains a source IP address 131, a destination IP address 132, and the operation 133.

The source IP address 131 and the destination IP address 132 are conditions for determining whether to execute the operation 133 of the record in question for a packet. The operation 133 indicates how a packet that meets the description of the record in question is to be processed.

As the source IP address 131 or the destination IP address 132, an IP address to be allocated to the user PC 116 belonging to a company is stored.

To give an example, a record 1263 holds as the source IP address 131 an IP address allocated to the user PC 116. As the destination IP address 132, the record 1263 holds the IP address of the VPN server 110 within the company H network 11. The operation 133 of the record 1263 indicates discard of a packet that meets the description of the record 1263. The router Z 91 accordingly picks up packets that are not destined to the VPN server 110 from among packets sent from the user PC 116, and discards the picked up packets.

A record 1264 holds as the source IP address 131 the IP address of the VPN server 110 within the company H network 11. As the destination IP address 132 of the record 1264, the record 1264 holds an IP address allocated to the user PC 116 belonging to the company “H”. The operation 133 of the record 1264 indicates discard of a packet that meets the description of the record 1264. The router Z 91 accordingly picks up packets that are not sent from the VPN server 110 from among packets destined to the user PC 116, and discards the picked up packets.

Steps 141 and 142 are therefore omitted from the processing performed by the computer system of the third embodiment. The rest of the processing performed by the computer system of the third embodiment is the same as the processing described in the second embodiment with reference to FIG. 13, and the description will not be repeated.

### Fourth Embodiment

In the second and third embodiments, the user PC 116 belonging to a company that has a corporate contract with the ISP “A” is allowed to have only VPN connection. However, holding every communication session via VPN connection as in the second and third embodiments is inefficient. A fourth embodiment of this invention allows the user PC 116 belonging to a company that has a corporate contract with the ISP “A” to have other connections in addition to VPN connection. In Internet communication of the user PC 116 belonging to a company that has a corporate contract with the ISP “A”, the fourth embodiment makes sure that an access policy of the company to which this user PC 116 belongs is applied before granting the user PC 116 access to the Internet.

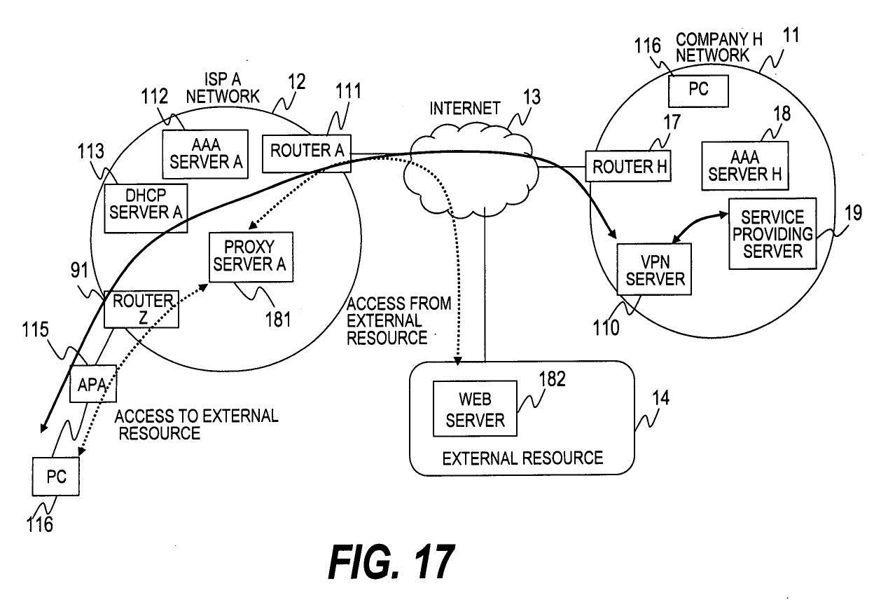

FIG. 17 is a block diagram showing the configuration of a computer system according to the fourth embodiment of this invention.

The computer system in the fourth embodiment of this invention has the same configuration as the computer system described in the second embodiment with reference to FIG. 9, except that the ISP A network 12 has a proxy server A 181. Components common to the second embodiment and the fourth embodiment will be denoted by the same reference symbols in order to avoid repetitive description.

The proxy server A 181 is a computer having a CPU, a memory, an interface, and the access policy settings table 26. The proxy server A 181 unitarily manages access from the user PC 116 to the external resource 14, thereby providing the user PC 116 with advanced security.

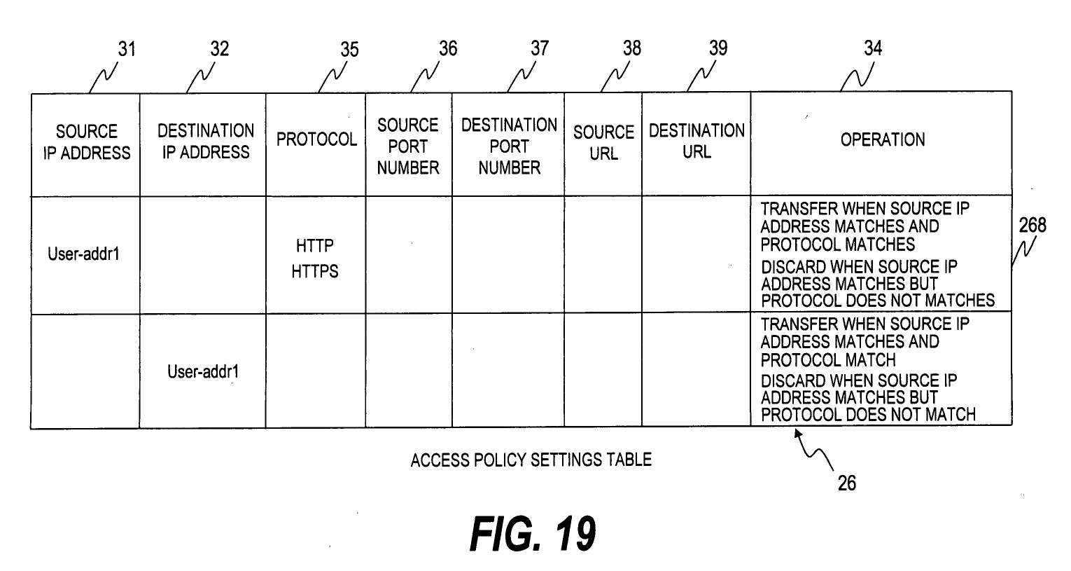

The access policy settings table 26 is used to manage access policies applied to communication of the user PC 116. Details of the access policy settings table 26 of the fourth embodiment will be described with reference to FIG. 19.

The external resource 14 has a Web server 182. The Web server 182 is a computer having a CPU, memory, and interface. The Web server 182 sends requested information from a user PC 116 to the user PC 116.

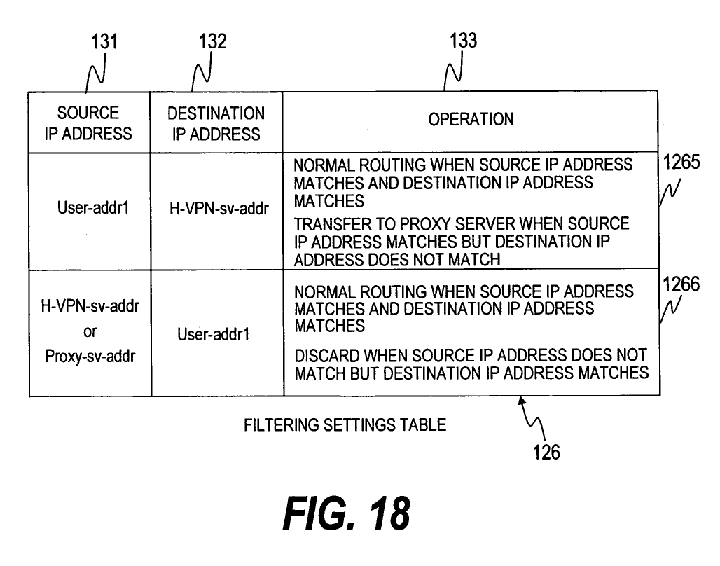

FIG. 18 is a configuration diagram of the filtering settings table 126 that is contained in the router Z 91 according to the fourth embodiment of this invention.

The filtering settings table 126 contains a source IP address 131, a destination IP address 132, and an operation 133.

The source IP address 131 and the destination IP address 132 are conditions for determining whether to execute the operation 133 of the record in question for a packet. The operation 133 indicates how a packet that meets the description of the record in question is to be processed.

For the source IP address 131 or the destination IP address 132, an IP address allocated to the user PC 116 belonging to a company is stored.

To give an example, a record 1265 holds as the source IP address 131 an IP address allocated to the user PC 116. As the destination IP address 132, the record 1265 holds the IP address of the VPN server 110 within the company H network 11. The operation 133 of the record 1265 indicates a transfer destination of a packet that meets the description of the record 1265. The router Z 91 accordingly picks up packets destined to the VPN server 110 out of packets sent from the user PC 116 that belongs to the company “H”, and transfers the picked up packets to the VPN server 110. On the other hand, of packets sent from the user PC 116 that belongs to the company “H”, packets that are not destined to the VPN server 110 are transferred to the proxy server A 181 by the router Z 91.

A record 1266 holds as the source IP address 131 the IP address of the VPN server 110 within the company H network 11 and the proxy server A 181 within the ISP A network 12. As the destination IP address 132, the record 1262 holds an IP address allocated to the user PC 116 that belongs to the company “H”. The operation 133 of the record 1266 indicates processing specifics of a packet that meets the description of the record 1266. The router Z 91 accordingly picks up packets sent from the VPN server 110 or the proxy server A 181 out of packets destined to the user PC 116 that belongs to the company “H”, and transfers the picked up packets to the user PC 116. On the other hand, of packets destined to the user PC 116 that belongs to the company “H”, packets that are not sent from the VPN server 110 or the proxy server A 181 are discarded by the router Z 91.

FIG. 19 is a configuration diagram of the access policy settings table 26 that is contained in the policy enforcer 114 according to the fourth embodiment of this invention.

Each record in the access policy settings table 26 shows one access policy, and the access policy settings table 26 contains a source IP address 31, a destination IP address 32, a protocol 35, a source port number 36, a destination port number 37, a destination URL 38, and an operation 34.

The source IP address 31 indicates the IP address of the source terminal of a packet to which an access policy shown by the record in question is applied. The destination IP address 32 indicates the IP address of the destination of a packet to which an access policy shown by the record in question is applied.

The protocol 35 indicates a protocol of a packet to which an access policy shown by the record in question is applied. The source port number 36 indicates the port number of the source terminal of a packet to which an access policy shown by the record in question is applied. The destination port number 37 indicates the port number of the destination of a packet to which an access policy shown by the record in question is applied. The source URL 38 indicates the URL of the source terminal of a packet to which an access policy shown by the record in question is applied. The destination URL 39 indicates the URL of the destination of a packet to which an access policy shown by the record in question is applied.

The operation 34 indicates specifics of the processing of an access policy shown by the record in question. For example, “transfer” or “discard” is stored as the operation 34.

To give an example, a record 268 holds as the source IP address 31 an IP address allocated to the user PC 116. The record 268 holds “HTTP” and “HTTPS” as the protocol 35.

The proxy server A 181 accordingly picks up packets that has the HTTP or HTTPS protocol out of packets sent from the user PC 116 that belongs to the company “H”, and transfers the picked up packets to their respective destinations. Of packets sent from the user PC 116 that belongs to the company “H”, packets that have other protocols than HTTP or HTTPS are discarded by the proxy server A 181.

In short, the ISP A network 12 exerts total or partial access control over the user PC 116. The user PC 116 in this embodiment is allowed to connect to the VPN server 110 and to connect to the external resource 14 with the use of a Web protocol.

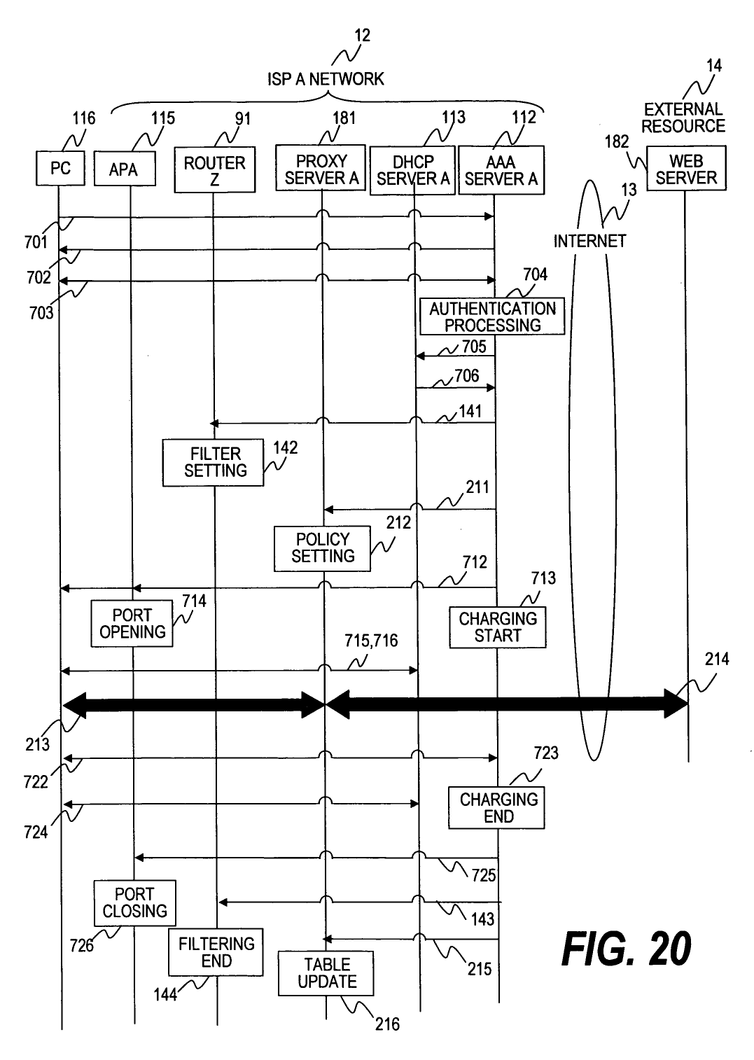

FIG. 20 is a sequence diagram of user access processing in the computer system according to the fourth embodiment of this invention.

This sequence diagram illustrates a case where the user PC 116 is successfully authenticated.

The company “H” has a corporate contract with the ISP “A”. The user data table 45 in the AAA server A 112 therefore holds information related to a user who belongs to the company “H”, and the corporate contract company list 46 holds information related to the company “H”.

Steps 701 to 706, and Step 141 and Step 142 are executed first. Steps 701 to 706, and Step 141 and Step 142 are the same as those in the user access processing performed by the computer system of the second embodiment of this invention in the manner as shown in FIG. 13, so the description will not be repeated.

After Step 142 is finished, the AAA server A 112 sends the control specifics 66 extracted in Step 141 and the IP address received in Step 706 to the proxy server A 181 (211).

The proxy server A 181 receives the control specifics 66 and the IP address. Using the received control specifics 66 and the IP address, the proxy server A 181 updates the access policy settings table 26 (212).

For example, the proxy server A 181 adds a new record to the access policy settings table 26. In the newly added record, the proxy server A 181 stores the received IP address as the source IP address 31. The proxy server A 181 stores “HTTP” and “HTTPS” as the protocol 35 in the newly added record. As the operation 34, the proxy server A 181 stores information indicated by the received control specifics 66 in the newly added record.

The proxy server A 181 adds another new record to the access policy settings table 26. In the newly added record, the proxy server A 181 stores the received IP address as the destination IP address 32. The proxy server A 181 stores “HTTP” and “HTTPS” as the protocol 35 in the newly added record. As the operation 34, the proxy server A 181 stores information indicated by the received control specifics 66 in the newly added record.

Steps 712 to 716 are subsequently executed. Steps 712 to 716 are the same as those in the user access processing shown in FIG. 13 performed by the computer system of the second embodiment, and the description will not be repeated.

Next, the user PC 116 accesses the Web server 182, which is within the external resource 14, via the proxy server A 181 (213 and 214). This is because the router Z 91 forwards packets that are sent from the user PC 116 and that are not destined to the VPN server 110 to the proxy server A 181.

When the user PC 116 subsequently ends the communication session, Steps 722 to 726 and Steps 143 and 144 are executed. Steps 722 to 726 and Steps 143 and 144 are the same as those in the user access processing performed by the computer system of the second embodiment in the manner shown in FIG. 13, and the description will not be repeated.

When Step 144 is finished, the AAA server A 112 notifies the proxy server A 181 of the end of the communication session held by the user PC 116 (215).

The proxy server A 181, upon notified of the end of the communication of the user PC 116, updates the access policy settings table 26 (216).

Specifically, the proxy server A 181 deletes from the access policy settings table 26 a record whose source IP address 31 of the access policy settings table 26 matches the IP address allocated to the user PC 116 that is about to end the communication session. The proxy server A 181 then deletes from the access policy settings table 26 a record whose destination IP address 32 of the access policy settings table 26 matches the IP address allocated to the user PC 116 that is about to end the communication session.

The computer system then ends the user access processing.

The user PC 116 may execute VPN connection and connection with the external resource 14 simultaneously. In this case, Steps 722 to 726, Steps 143 and 144, and Steps 215 and 216 are executed when the user PC 116 finishes all communication sessions.

The proxy server A 181 in this embodiment controls communication based on the protocol type, but may instead control communication based on the URL, the port number, or the like.

An access policy applied to communication of the user PC 116 that is connected to the AP A 115 and an access policy applied to communication of the user PC 116 that is within the company H network 11 may be identical with or different from each other.

In this embodiment, an access policy is registered in advance as the control specifics 66 of the corporate contract company list 46, which is contained in the AAA server A 112, but advance registration of the access policy to the corporate contract company list 46, which is contained in the AAA server A 112 is not always necessary. In this case, the AAA server A 112 obtains the access policy from the AAA server H 18 of the company H network 11 as in the first embodiment.

### Fifth Embodiment

In the first to fourth embodiments of this invention, the user PC 116 is connected to an ISP network that has a corporate contract with a company to which the user PC 116 belongs. On the other hand, a fifth embodiment of this invention describes a case in which the user PC 116 is connected to an ISP network that does not have a corporate contract with a company to which the user PC 116 belongs.

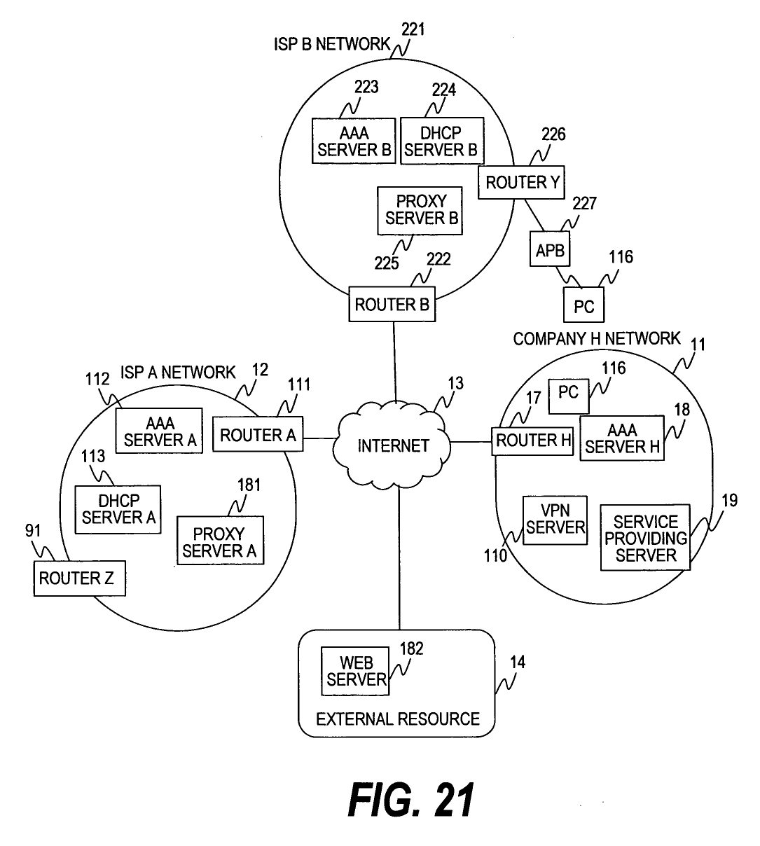

FIG. 21 is a block diagram showing the configuration of a computer system according to the fifth embodiment of this invention.

The computer system of the fifth embodiment has the company H network 11, the ISP A network 12, an ISP B network 221, the Internet 13, and the external resource 14. The company H network 11, the ISP A network 12, the Internet 13, and the external resource 14 are the same as those in the computer system of the fourth embodiment. Components common to the fourth embodiment and the fifth embodiment will be denoted by the same reference symbols in order to avoid repetitive description.

However, in the fifth embodiment, the AAA server A 112 within the ISP A network 12 has additional lists: a roaming contract ISP list 261 and a corporate contract company roaming condition list 271.

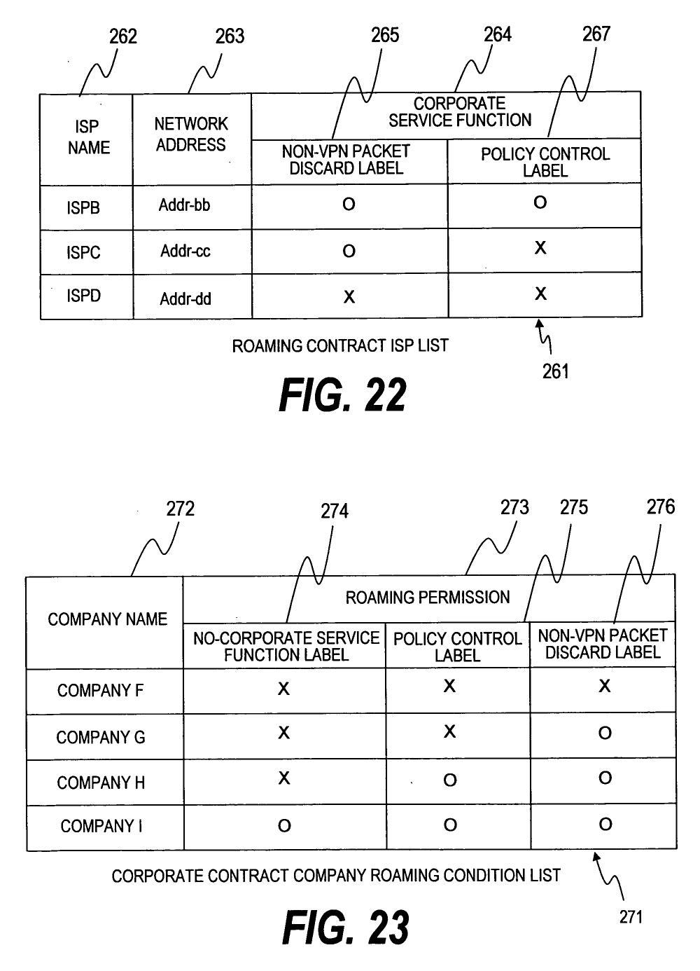

The roaming contract ISP list 261 shows whether or not an ISP has a corporate service function. Details of the roaming contract ISP list 261 will be described with reference to FIG. 22.

The corporate contract company roaming condition list 271 shows conditions for allowing roaming. Details of the corporate contract company roaming condition list 271 will be described with reference to FIG. 23.

The ISP B network 221 is a network provided by an Internet service provider (ISP) “B”. In this embodiment, the company “H” has a corporate contract with the ISP “A”, and the ISP “A” and the ISP “B” have a roaming contract with each other.

The ISP B network 221 is connected to at least one AP Bs 227. The AP B 227 is an access point (AP) connected to the user terminal device (user PC) 116 by cable or radio.

The ISP B network 221 has a router B 222, an AAA server B 223, a DHCP server B 224, a proxy server B 225, and a router Y 226. FIG. 21 shows one router B 222, AAA server B 223, DHCP server B 224, proxy server B 225, and router Y 226, but the ISP B network 221 may have two or more of each of those components.

The router Y 226 is connected to the AP B 227. The router Y 226 receives packets and transfers the received packets. The router Y 226 also controls communication of the user PC 116 in accordance with an access policy. The configuration of the router Y 226 is the same as that of the router Z 91 shown in FIG. 11, and its description will be omitted here.

The DHCP server B 224 is a computer having a CPU, a memory, and an interface. The DHCP server B 224 automatically allocates necessary information which includes an IP address to the user PC 116 which is connected to the Internet 13.

The AAA server B 223 performs authentication on the user PC 116. The configuration of the AAA server B 223 is the same as that of the AAA server A 112 shown in FIG. 4, and its description will be omitted here.

The router B 222 is connected to the Internet 13. The router B 222 receives packets and transfers the received packets.

As shown in FIG. 19, the proxy server B 225 is a computer having a CPU, a memory, an interface, and the access policy settings table 26. The proxy server B 225 unitarily manages access from the user PC 116 to the external resource 14, thereby providing the user PC 116 with advanced security.

The access policy settings table 26 is used to manage access policies applied to communication of the user PC 116.

FIG. 22 is a configuration diagram of the roaming contract ISP list 261 which is contained in the AAA server A 112 according to the fifth embodiment of this invention.

The roaming contract ISP list 261 contains in each record entry an ISP name 262, a network address 263, and a corporate service function 264.

The ISP name 262 indicates an identifier unique to each ISP. The network address 263 indicates the address of a network provided by an ISP that is identified by the ISP name 262 of the record in question.

The corporate service function 264 indicates whether or not an ISP identified by the ISP name 262 of the record in question has a corporate service function. Specifically, the corporate service function 264 includes a non-VPN packet discard label 265 and a policy control label 267.

The non-VPN packet discard label 265 indicates whether or not an ISP identified by the ISP name 262 of the record in question can control communication in accordance with an access policy that only allows VPN connection. In a case where the ISP in question can control communication in accordance with an access policy that only allows VPN connection, a circular mark, for example, is stored as the non-VPN packet discard label 265.

The policy control label 267 indicates whether or not an ISP identified by the ISP name 262 of the record in question can control communication in accordance with every access policy. In a case where the ISP in question can control communication in accordance with every access policy, a circular mark, for example, is stored as the policy control label 267.

FIG. 23 is a configuration diagram of the corporate contract company roaming condition list 271 which is contained in the AAA server A 112 according to the fifth embodiment of this invention.

The corporate contract company roaming condition list 271 contains in each record entry a company name 272 and a roaming permission 273.

The company name 272 indicates an identifier unique to each company that has a corporate contract with the ISP “A”. The roaming permission 273 indicates whether or not a company identified by the company name 272 of the record in question allows communication that utilizes roaming. Specifically, the roaming permission 273 includes a no-corporate service function label 274, a policy control label 275, and a non-VPN packet discard label 276.

The no-corporate service function label 274 indicates whether or not a company identified by the company name 272 of the record in question agrees to roaming that uses an ISP with no corporate service function. In a case where the company in question allows roaming that uses an ISP with no corporate service function, a circular mark, for example, is stored as the no-corporate service function label 274.

The policy control label 275 indicates whether or not a company identified by the company name 272 of the record in question agrees to roaming that uses an ISP capable of controlling communication in accordance with every access policy. In a case where the company in question agrees to roaming that uses an ISP capable of controlling communication in accordance with every access policy, a circular mark, for example, is stored as the policy control label 275.

The non-VPN packet discard label 276 indicates whether or not a company identified by the company name 272 of the record in question agrees to roaming that uses an ISP capable of controlling communication in accordance with an access policy that only allows VPN connection. In a case where the company in question agrees to roaming that uses an ISP capable of controlling communication in accordance with an access policy that only allows VPN connection, a circular mark, for example, is stored as the non-VPN packet discard label 276.

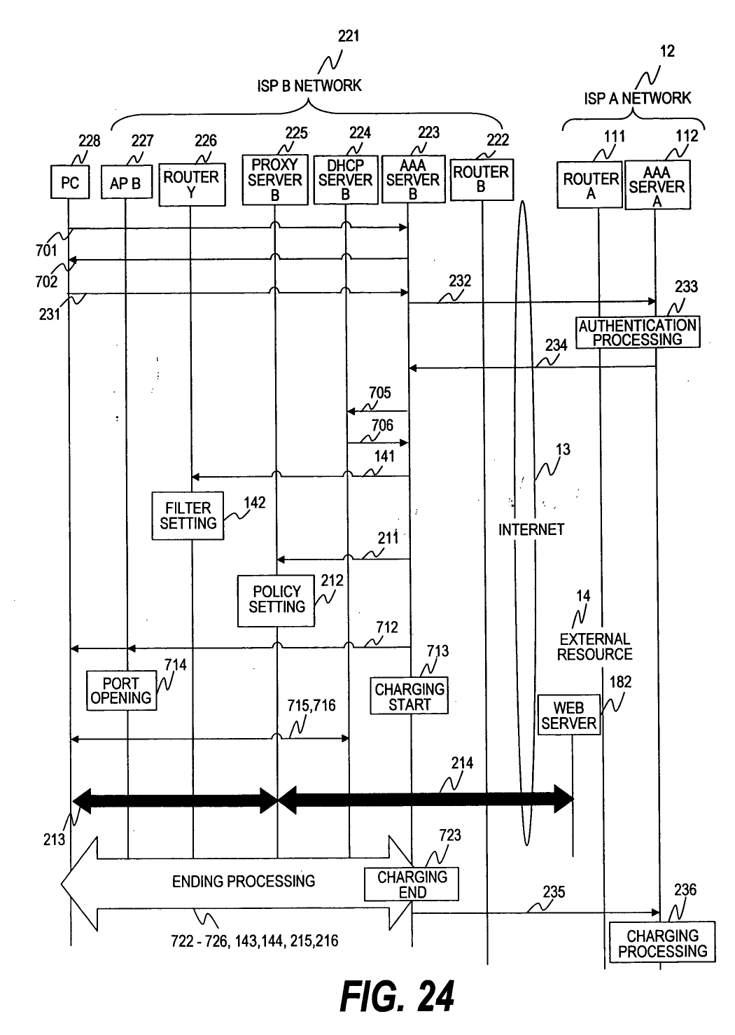

FIG. 24 is a sequence diagram of user access processing in the computer system according to the fifth embodiment of this invention.

This sequence diagram illustrates a case where the user PC 116 is successfully authenticated.

The company “H” has a corporate contract with the ISP “A”. The user data table 45 in the AAA server A 112 therefore holds information related to a user who belongs to the company “H”, and the corporate contract company list 46 in the AAA server A 112 holds information related to the company “H”.

First, the user PC 116 sends an access request to the AAA server B 223 via the AP B 227 and the router Y 226 (701). The AAA server B 223 receives the access request. The AAA server B 223 then sends an authentication information request via the AP B 227 and the router 226 to the user PC 116 that has sent the access request (702).

The user PC 116 receives the authentication information request. The user PC 116 then sends a user ID and a password to the AAA server B 223 via the AP B 227 and the router Y 226. The user PC 116 here sends authentication information that contains a user ID “H-1@ISPA” and a password to the AAA server B 223 (231). The user ID “H-1@ISPA” is made up of a user ID assigned by the ISP “A” and the identifier of this ISP “A” attached thereto.

The AAA server B 223 receives a user ID and a password. At this point, the AAA server B 223 obtains the MAC address of the user-PC 116.

The AAA server B 223 next identifies an ISP that has a contract with a company to which a user identified by the received user ID belongs based on the received user ID. Here, the AAA server B 223 identifies the ISP “A” as an ISP that has a contract with a company to which a user identified by the received user ID belongs.

The AAA server B 223 sends the received user ID and password to the AAA server A 112, which is within the ISP A network 12, to request the AAA server A 112 within the ISP A network 12 to perform authentication (232).

Upon reception of the user ID and the password, the AAA server A 112 within the ISP A network 12 performs authentication processing as requested (233). Specifically, the AAA server A 112 chooses from the user data table 45 a record whose user ID 51 of the user data table 45 matches the received user ID. From the chosen record, the AAA server A 112 extracts the password 52 and the company name 53.

The AAA server A 112 judges whether or not the received password matches the extracted password 52, thereby performing authentication on the user PC 116 (704).

When the received password does not match the extracted password 52, the AAA server A 112 judges that the user PC 116 has failed in passing authentication.

On the other hand, when the received password matches the extracted password 52, the AAA server A 112 judges that the user PC 116 has successfully been authenticated. Then the AAA server A 112 chooses from the corporate contract company list 46 a record whose company name 61 of the corporate contract company list 46 matches the extracted company name 53. From the chosen record, the AAA server A 112 extracts the VPN server address 65 and the control specifics 66.

The AAA server A 112 next notifies the AAA server B 223, which is within the ISP B network 221, of the authentication success. The AAA server A 112 also sends the extracted VPN server address 65 and control specifics 66 to the AAA server B 223 within the ISP B network 221 (234).

Subsequent processing is the same as the one performed by the computer system of the forth embodiment in the manner shown in FIG. 20, and the description will be omitted here. However, this embodiment differs from the fourth embodiment in that the processing is executed by the router B 222, the AAA server B 223, the DHCP server B 224, the proxy server B 225, and the router Y 226, which are provided in the ISP B network 221.

Another difference is that, when the user PC 116 ends the communication session, the AAA server B 223 notifies the AAA server A 112 within the ISP A network 12 of charging information of the user PC 116 (235). The AAA server A 112 executes charging processing based on the notified charging information (236).

The computer system then ends the user access processing.

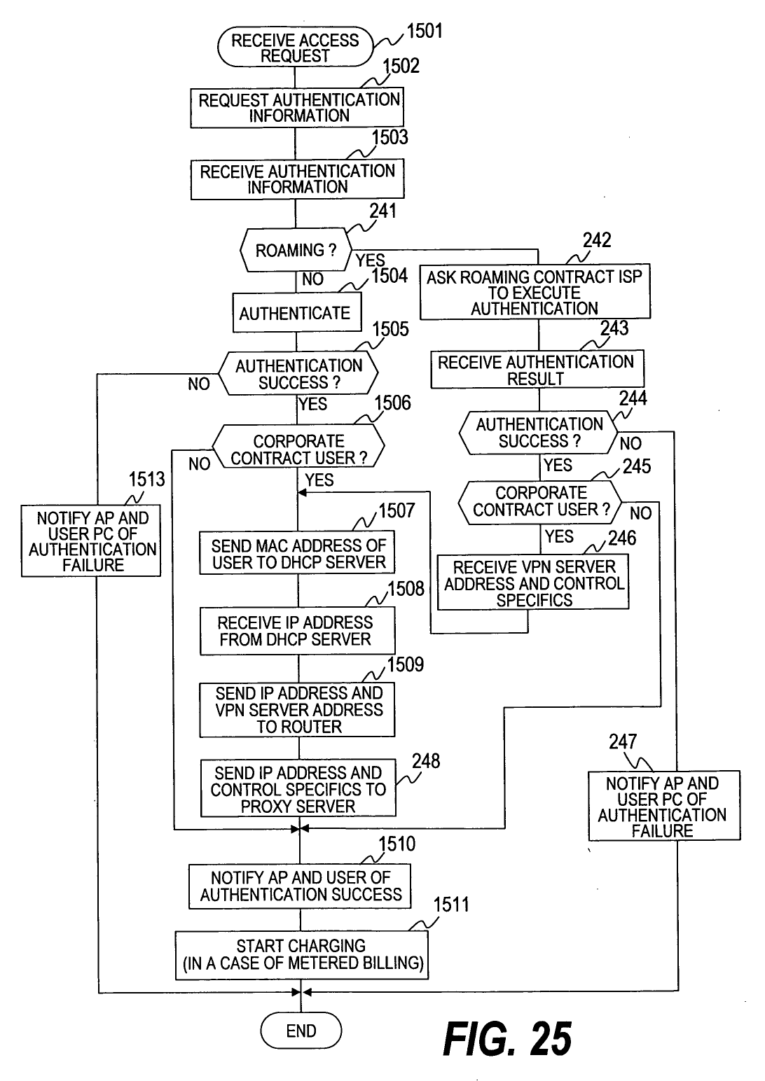

FIG. 25 is a flow chart for authentication processing of the AAA server B 223 within the ISP B network 221 according to the fifth embodiment of this invention.

The AAA server B 223 receives an access request from the user PC 116 (1501), and starts the authentication processing.

First, the AAA server B 223 sends an authentication information request to the user PC 116 that has sent the access request (1502). Upon reception of the authentication information request, the user PC 116 sends authentication information which contains a user ID and a password.

The AAA server B 223 receives the authentication information containing a user ID and a password (1503). At this point, the AAA server B 223 obtains the MAC address of the user PC 116.

The AAA server B 223 next judges whether or not a user identified by the received user ID is requesting access that utilizes roaming based on the received user ID.

Next, when the use in question is not requesting access that utilizes roaming, the AAA server B 223 chooses from the user data table 45 a record whose user ID 51 of the user data table 45 matches the received user ID. From the chosen record, the AAA server B 223 next extracts the password 52 and the company name 53.

The AAA server B 223 next performs authentication on the user PC 116 by judging whether or not the received password matches the extracted password 52 (1504).

When the received password does not match the extracted password 52, the AAA server B 223 judges that the user PC 116 has failed in passing authentication (1505). Then the AAA server B 223 notifies the AP B 227 and the user PC 116 of the authentication failure (1513). The AAA server B 223 then ends the authentication processing.

When the received password matches the extracted password 52, on the other hand, the AAA server B 223 judges that the user PC 116 has successfully been authenticated (1505). Then the AAA server B 223 judges whether or not the extracted company name 53 holds a value. The AAA server B 223 thus judges whether or not a company to which a user identified by the received use ID belongs has a corporate contract with the ISP “B” (1506).

When the extracted company name 53 holds no value, it means that a company to which a user identified by the received use ID belongs does not have a corporate contract with the ISP “B”. Then the AAA server B 223 proceeds directly to Step 1510, where the AAA server B 223 notifies the AP B 227 and the user PC 116 of the authentication success.

When the extracted company name 53 holds a value, it means that a company to which a user identified by the received user ID belongs has a corporate contract with the ISP “B”. Then the AAA server B 223 sends the obtained MAC address of the user PC 116 to the DHCP server B 224 (1507).

The AAA server B 223 receives the IP address to be allocated to the user PC 116 from DHCP server B 224 (1508). The AAA server B 223 then chooses from the corporate contract company list 46 a record whose company name 61 of the corporate contract company list 46 matches the extracted company name 53. From the chosen record, the AAA server B 223 extracts the VPN server address 65 and the control specifics 66.

The AAA server B 223 sends the extracted VPN server address 65, the extracted control specifics 66, and the received IP address to the router Z 226 (1509).

The AAA server B 223 then sends the extracted control specifics 66, and the received IP address to the proxy server B225 (248).

The AAA server B 223 subsequently notifies the AP B 227 and the user PC 116 of the authentication success (1510). In the case of metered billing, the AAA server B 223 also starts collecting information necessary for charging (1511).

The AAA server B 223 then ends the authentication processing.

When the user in question is requesting access that utilizes roaming, on the other hand, the AAA server B 223 identifies an IPS that has a contract with a company to which the user identified by the received user ID belongs based on the received user ID.

Next, the AAA server B 223 sends the received user ID and password to the AAA server, which is within the specified ISP, to request the AAA server within the specified ISP to perform authentication (242).

The AAA server B 223 stands by until an authentication result is received. Upon reception of an authentication result (243), the AAA server B 223 judges whether or not the received authentication result indicates an authentication success (244).

When the authentication result indicates an authentication failure, the AAA server B 223 notifies the AP B 227 and the user PC 116 of the authentication failure (247). The AAA server B 223 then ends the authentication processing.

When the authentication result indicates an authentication success, the AAA server B 223 judges whether or not a company to which the user identified by the received user ID belongs has a corporate contract with an ISP. Specifically, the AAA server B 223 judges whether or not a VPN server address and control specifics have been received along with the authentication result.

In a case where the AAA server B 223 has not received a VPN server address and control specifics, it means that a company to which this user belongs does not have a corporate contract with an ISP. Then the AAA server B 223 proceeds to Step 1510.

On the other hand, in a case where the AAA server B 223 has received a VPN server address and control specifics (246), it means that a company to which this user belongs has a corporate contract with an ISP. Then the AAA server B 223 proceeds to Step 1507.

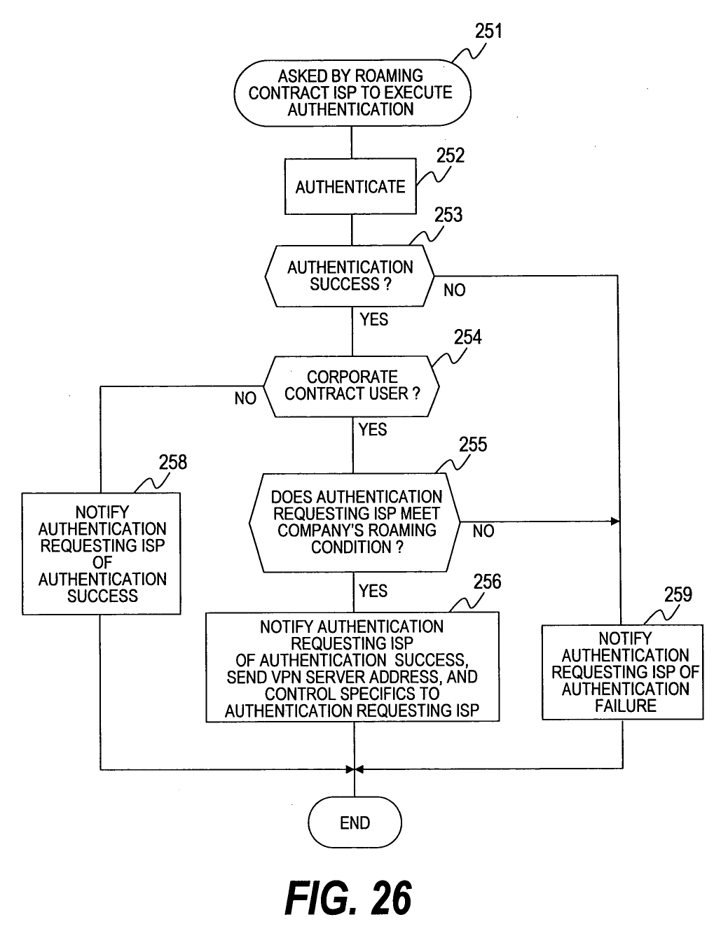

FIG. 26 is a flow chart for authentication processing of the AAA server A 112 according to the ISP A network 12 according to the fifth embodiment of this invention.

The AAA server A 112 is asked by an AAA server of another ISP (authentication requesting AAA server) to perform authentication (251). In making this request, the authentication requesting AAA server sends a user ID and a password to the AAA server A 112.

The AAA server A 112 next chooses from the user data table 45 a record whose user ID 51 of the user data table 45 matches the received user ID. From the chosen record, the AAA server A 112 extracts the password 52 and the company name 53.

The AAA server A 112 next performs authentication on the user PC 116 by judging whether or not the received password matches the extracted password 52 (252).

When the received password does not match the extracted password 52, the AAA server A 112 judges that the user PC 116 has failed in passing authentication (253). Then the AAA server A 112 notifies the authentication requesting AAA server of the authentication failure (259). The AAA server A 112 then ends the authentication processing.

When the received password matches the extracted password 52, on the other hand, the AAA server A 112 judges that the user PC 116 has successfully been authenticated (253). Then the AAA server A 112 judges whether or not the extracted company name 53 holds a value. The AAA server A 112 thus judges whether or not a company to which a user identified by the received use ID belongs has a corporate contract with the ISP “A” (254).

When the extracted company name 53 holds no value, it means that a company to which a user identified by the received user ID belongs does not have a corporate contract with the ISP “A”. Then the AAA server A 112 notifies the authentication requesting AAA server of the authentication success (258). The AAA server A 112 thereafter ends the authentication processing.

When the extracted company name 53 holds a value, it means that a company to which a user identified by the received user ID belongs has a corporate contract with the ISP “A”. Then the AAA server A 112 judges whether or not the ISP that has the authentication requesting AAA server meets roaming conditions of the company to which the user identified by the received user ID belongs (255).

Specifically, the AAA server A 112 chooses from the corporate contract company roaming condition list 271 a record whose company name 272 of the corporate contract company roaming condition list 271 matches the extracted company name 53. From the chosen record, the AAA server A 112 extracts the no-corporate service function label 274, the policy control label 275, and the non-VPN packet discard label 276.

The AAA server A 112 next chooses from the roaming contract ISP list 261 a record whose ISP name 262 of the roaming contract ISP list 261 matches the identifier of the ISP that has the authentication requesting AAA server. From the chosen record, the AAA server A 112 extracts the non-VPN packet discard label 265 and the policy control label 267.

The AAA server A 112 judges whether or not a circular mark is stored as the extracted no-corporate service function label 274.

When a circular mark is stored as the extracted no-corporate service function label 274, the AAA server A 112 judges that the ISP that has the authentication requesting AAA server meets the roaming conditions. Then the AAA server A 112 proceeds to Step 256.

In a case where a cross mark is stored as the extracted no-corporate service function label 274, the AAA server A 112 judges whether or not a circular mark is stored as the extracted non-VPN packet discard label 265 and the extracted non-VPN packet discard label 276 both.

When a circular mark is stored as the extracted non-VPN packet discard label 265 and the extracted non-VPN packet discard label 276, the AAA server A 112 judges that the ISP that has the authentication requesting AAA server meets the roaming conditions. Then the AAA server A 112 proceeds to Step 256.

In a case where a cross mark is stored as at least one of the non-VPN packet discard label 265 and the non-VPN packet discard label 276, the AAA server A 112 judges whether or not a circular mark is stored as the extracted policy control label 275 and the extracted policy control label 267 both.

When a circular mark is stored as the policy control label 275 and the policy control label 267 both, the AAA server A 112 judges that the ISP that has the authentication requesting AAA server meets the roaming conditions. Then the AAA server A 112 proceeds to Step 256.

In a case where a cross mark is stored as at least one of the policy control label 275 and the policy control label 267, the AAA server A 112 judges that the ISP that has the authentication requesting AAA server does not meet the roaming conditions. Then the AAA server A 112 notifies the authentication requesting AAA server of the authentication failure (259). The AAA server A 112 thereafter ends the authentication processing.

When the ISP that has the authentication requesting AAA server meets the roaming conditions, the AAA server A 112 chooses from the corporate contract company list 46 a record whose company name 61 of the corporate contract company list 46 matches the extracted company name 53. From the chosen record, the AAA server A 112 extracts the VPN server address 65 and the control specifics 66.

The AAA server A 112 next notifies the authentication requesting AAA server of the authentication success. In notifying the authentication success, the AAA server A 112 sends the extracted VPN server address 65 and the extracted control specifics 66 to the authentication requesting AAA server (256). The AAA server A 112 then ends the authentication processing.

As described above, according to this embodiment, an access policy of a company is applied to communication held by the user PC 116 utilizing roaming as well as local communication of the user PC 116.

### Sixth Embodiment

In the fifth embodiment, an access policy of the company “H” is registered in advance in the AAA server A 112 which is within the ISP A network 12. On the other hand, in a sixth embodiment of this invention, the AAA server A 112 within the ISP A network 12 obtains an access policy from the AAA server H 18, which is provided in the company H network, when authentication processing is executed.

A computer system according to the sixth embodiment of this invention has the same configuration as the computer system described in the fifth embodiment with reference to FIG. 21, and its description will be omitted here.

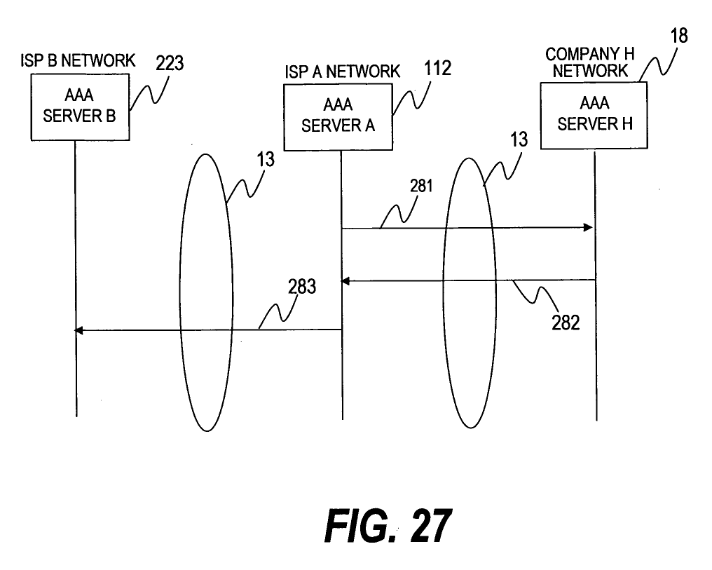

FIG. 27 is a sequence diagram of a part of user access processing in the computer system according to the sixth embodiment of this invention.

Steps 701 and 702 and steps 231 to 233 are executed first. Steps 701 and 702 and Steps 231 to 233 are the same as those in the user access processing performed by the computer system of the fifth embodiment in the manner shown in FIG. 24, and the description will not be repeated.

Next, the AAA server A 112 within the ISP A network 12 sends an access policy request to the AAA server H 18 within the company H network 11 (281).

The AAA server H 18 receives the access policy request. The AAA server H 18 then sends an access policy that is applied to communication of the user PC 116 to the AAA server A 112 within the ISP A network 12 (282).

The AAA server A 112 receives the access policy from the AAA server H 18. The AAA server A 112 sends the received access policy to the AAA server B 223 within the ISP B network 221 along with an authentication success notification (283). Thereafter, Step 705 and subsequent steps are executed. Step 705 and subsequent steps in this embodiment are the same as those in the user access processing performed by the computer system of the fifth embodiment in the manner shown in FIG. 24, and the description will not be repeated.

### Seventh Embodiment

In the fifth and sixth embodiments, an ISP and another ISP have a roaming contract with each other. In a seventh embodiment of this invention, a roaming mediating server 291 mediates roaming.

A computer system according to the seventh embodiment has the same configuration as the computer system of the fifth embodiment shown in FIG. 21 except for the roaming mediating server 291. The roaming mediating server 291 is run by a business entity that provides a roaming mediating service. As shown in FIG. 22, the roaming mediating server 291 is connected to the Internet 13. The roaming mediating server 291 is a computer having a CPU, a memory, an interface, and the roaming contract ISP list 261.

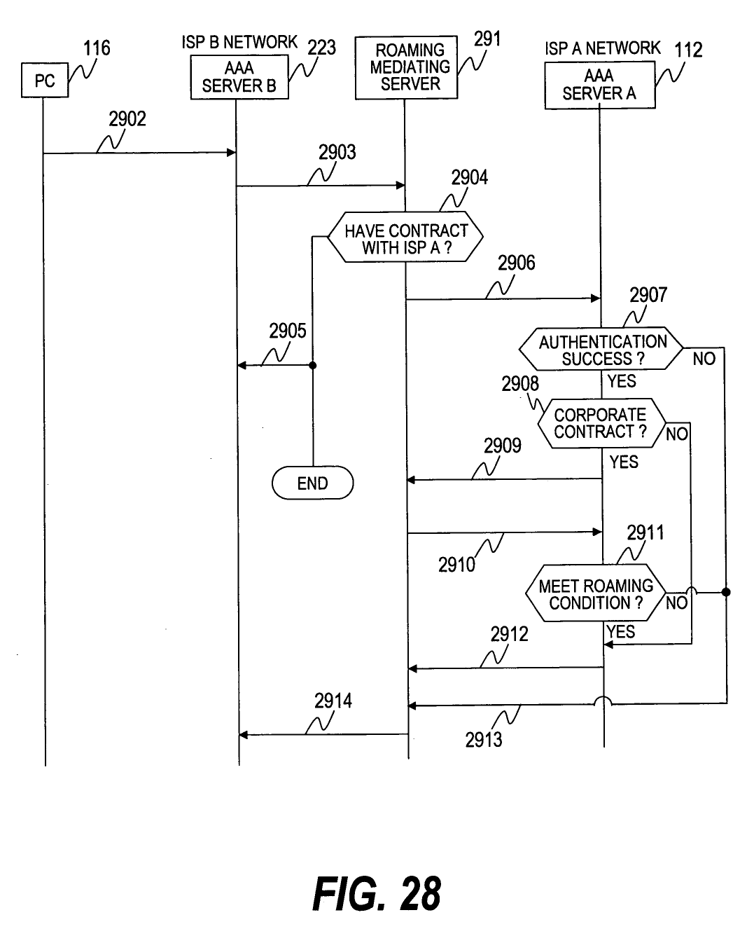

FIG. 28 is a sequence diagram of a part of user access processing in the computer system according to the seventh embodiment of this invention.

Steps 701 and 702 are executed first. Steps 701 and 702 are the same as those in the user access processing performed by the computer system of the fifth embodiment in the manner shown in FIG. 24, and the description will not be repeated.

Next, the user PC 116 then sends authentication information containing a user ID and a password to the AAA server B 223 via the AP B 227 and the router Y 226 (2902).

The AAA server B 223 receives the authentication information containing a user ID and a password. At this point, the AAA server B 223 obtains the MAC address of the user PC 116.

The AAA server B 223 requests the roaming mediating server 291 to perform authentication (2903). At this point, the AAA server B 223 sends the received user ID and password to the roaming mediating server 291.

The roaming mediating server 291 receives a user ID and a password. The roaming mediating server 291 next identifies an ISP that has a contract with a company to which a user identified by the received user ID belongs, based on the received user ID. Here, the roaming mediating server 291 identifies the ISP “A” as an ISP that has a contract with a company to which a user identified by the received user ID belongs.

The roaming mediating server 291 judges whether or not its roaming mediator has a contract with the identified ISP “A” (2904).

When the roaming mediator and the identified ISP “A” do not have a contract, the roaming mediating server 291 notifies the AAA server B 223 of the authentication failure (2905).

When the roaming mediator and the identifier ISP “A” have a contract, the roaming mediating server 291 requests the AAA server A 112 within the ISP A network 12 to perform authentication (2906). In making the request, the roaming mediating server 291 sends the received user ID and password to the AAA server A 112 within the ISP A network 12.

The AAA server A 112 receives a user ID and a password. The AAA server A 112 next chooses from the user data table 45 a record whose user ID 51 matches the received user ID. From the chosen record, the AAA server A 112 extracts the password 52 and the company name 53.

The AAA server A 112 next performs authentication on the user PC 116 by judging whether or not the received password matches the extracted password 52 (2907).

When the received password does not match the extracted password 52, the AAA server A 112 judges that the user PC 116 has failed in passing authentication. Then the AAA server A 112 notifies the roaming mediating server 291 of the authentication failure (2913).

When the received password matches the extracted password 52, on the other hand, the AAA server A 112 judges that the user PC 116 has successfully been authenticated. Then the AAA server A 112 judges whether or not the extracted company name 53 holds a value. The AAA server A 112 thus judges whether or not a company to which a user identified by the received user ID belongs has a corporate contract with the ISP “A” (2908).

When the extracted company name 53 holds no value, it means that a company to which a user identified by the received user ID belongs does not have a corporate contract with the ISP “A”. Then the AAA server A 112 notifies the roaming mediating server 291 of the authentication success.

When the extracted company name 53 holds a value, it means that a company to which a user identified by the received user ID belongs has a corporate contract with the ISP “A”. Then the AAA server A 112 asks the roaming mediating server 291 what corporate service function the ISP “B” has (2909).

Upon reception of the inquiry, the roaming mediating server 291 identifies from the roaming contract ISP list 261 a corporate service function that the ISP “B” has. The roaming mediating server 291 sends the identified corporate service function to the AAA server A 112 (2910).

Next, the roaming mediating server 291 judges whether or not ISP “B” meets roaming conditions of the company to which the user identified by the received user ID belongs (2911).

When the ISP “B” does not meet the roaming conditions, the AAA server A 112 notifies the roaming mediating server 291 of the authentication failure (2913).

When the ISP “B” meets the roaming conditions, the AAA server A 112 chooses from the corporate contract company list 46 a record whose company name 61 matches the extracted company name 53. From the chosen record, the AAA server A 112 extracts the VPN server address 65 and the control specifics 66.

The AAA server A 112 next notifies the roaming mediating server 291 of the authentication success. In notifying the authentication success, the AAA server A 112 sends the extracted VPN server address 65 and the extracted control specifics 66 to the roaming mediating server 291 (2912).

The roaming mediating server 291 receives the authentication result and sends the received authentication result to the AAA server B 223, which has requested the authentication. In a case where the VPN server address 65 and the control specifics 66 are received, the roaming mediating server 291 sends the received VPN server address 65 and control specifics 66 to the authentication requesting AAA server B 223 (2913).

Thereafter, Step 705 and subsequent steps are executed. Step 705 and subsequent steps in this embodiment are the same as those in the user access processing performed by the computer system of the fifth embodiment in the manner shown in FIG. 24, and the description will not be repeated. The difference from the fifth embodiment is that the AAA server B 223 notifies charging information of the user PC 116 to the roaming mediating server 291, instead of to the AAA server A 112. The roaming mediating server 291 then notifies the AAA server A 112 of the charging information received from the AAA server B 223.

### Eighth Embodiment

In an eighth embodiment of this invention, a user ID is assigned to each company instead of each individual user.

The eighth embodiment is applicable to any of the first to seventh embodiments.

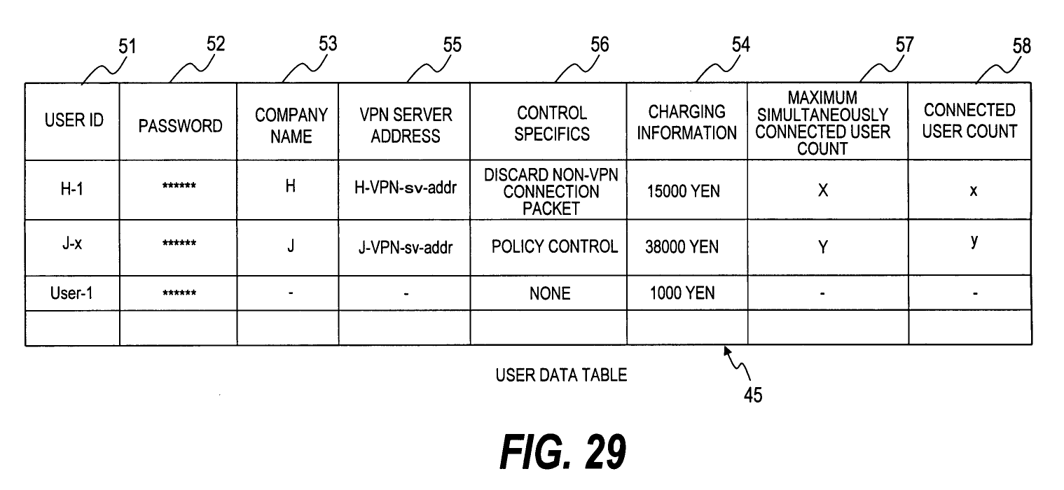

FIG. 29 is a configuration diagram of the user data table 45 that is stored in the AAA server A 112 according to the eighth embodiment of this invention.

The user data table 45 contains a user ID 51, a password 52, a company name 53, a charging information 54, a VPN server address 55, a control specifics 56, a maximum simultaneously connected user count 57 and a connected user count 58.

The user ID 51 indicates an identifier unique to each user of the ISP. The password 52 indicates a password set to a user who is identified by the user ID 51 of the record in question. The company name 53 indicates an identifier unique to a company to which the user ID 51 of the record in question is assigned. The charging information 54 indicates the amount of money charged to a user who is identified by the user ID 51 of the record in question.

The VPN server address 55 indicates the IP address of the VPN server 110 within the intranet of a company that is identified by the company name 53 of the record in question. The control specifics 56 indicate what control is exerted on communication of the user PC 116 belonging to a company that is identified by the company name 53 of the record in question.

The maximum simultaneously connected user count 57 indicates how many user PCs 116 can be connected simultaneously with the user ID 51 of the record in question. The connected user count 58 indicates how many user PCs 116 are currently connected with the user ID 51 of the record in question.

The AAA server A 112 in this embodiment performs authentication processing (704) in which a record whose user ID 51 matches the received user ID is chosen from the user data table 45. The AAA server A 112 next compares the maximum simultaneously connected user count 57 and connected user count 58 of the chosen record. When the maximum simultaneously connected user count 57 is larger than the connected user count 58, the AAA server A 112 allows the user PC 116 to connect. The AAA server A 112 then adds “1” to the connected user count 58 of the chosen record.

When the maximum simultaneously connected user count 57 is equal to the connected user count 58, the AAA server A 112 does not allow the user PC 116 to connect.

When the user PC 116 finishes the communication session, the AAA server A 112 subtracts “1” from the connected user count 58.

According to the eighth embodiment, user IDs managed by a company can be reduced in number.

It should be noted that, a user ID may be assigned to each department or post in a company instead of each company. In this case, it is possible to set different access policies from one department or post to another.

### Ninth Embodiment

Authentication is performed by an AAA server of an ISP network in the first to eighth embodiments. In a ninth embodiment of this invention, it is an AAA server of a company that conducts authentication.

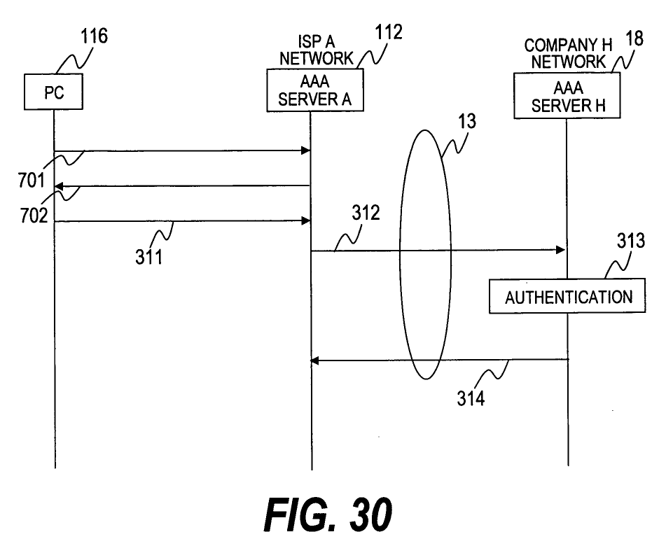

FIG. 30 is a sequence diagram showing a part of user access processing that is performed by a computer system according to the ninth embodiment of this invention.

This sequence diagram illustrates a case where the user PC 116 is successfully authenticated.

The company “H” has a roaming contract with the ISP “A”.

Steps 701 and 702 are executed first. Steps 701 and 702 are the same as those in the user access processing performed by the computer system of the first embodiment in the manner shown in FIG. 7, and the description will not be repeated.

Next, the user PC 116 sends authentication information containing a user ID and a password to the AAA server A 112 within the ISP A network 12 (311). The user ID sent from the user PC 116 to the AAA server A 112 has the identifier of the company “H” attached thereto.

The AAA server A 112 receives a user ID and a password. At this point, the AAA server B 223 obtains the MAC address of the user PC 116.

The AAA server A 112 next identifies a company “H” to which a user identified by the received user ID belongs based on the received user ID.

The AAA server A 112 request the identified company AAA server H 18 to perform authentication (312). The AAA server A 112 sends the received user ID and password to the AAA server H 18.

The AAA server H 18 performs authentication on the user PC 116 as requested (313). The AAA server H 18 notifies the AAA server A 12 of the result of the authentication. In a case where the user PC 116 is successfully authenticated, the AAA server H 18 sends an access policy to be applied to communication held by the user PC 116 to the AAA server A 112.

Thereafter, Step 705 and subsequent steps are executed. Step 705 and subsequent steps in this embodiment are the same as those in the user access processing performed by the computer system of the first embodiment in the manner shown in FIG. 7, and the description will not be repeated.

### Tenth Embodiment

Authentication in the first to ninth embodiments uses a user ID and a password. In a tenth embodiment of this invention, on the other hand, authentication uses electronic certificates.

Authentication in the tenth embodiment employs extensible authentication protocol-transport layer security (EAP-TLS), which is one of the 802.1X authentication sequences. EAP-TLS is described in IETF RFC 3748.

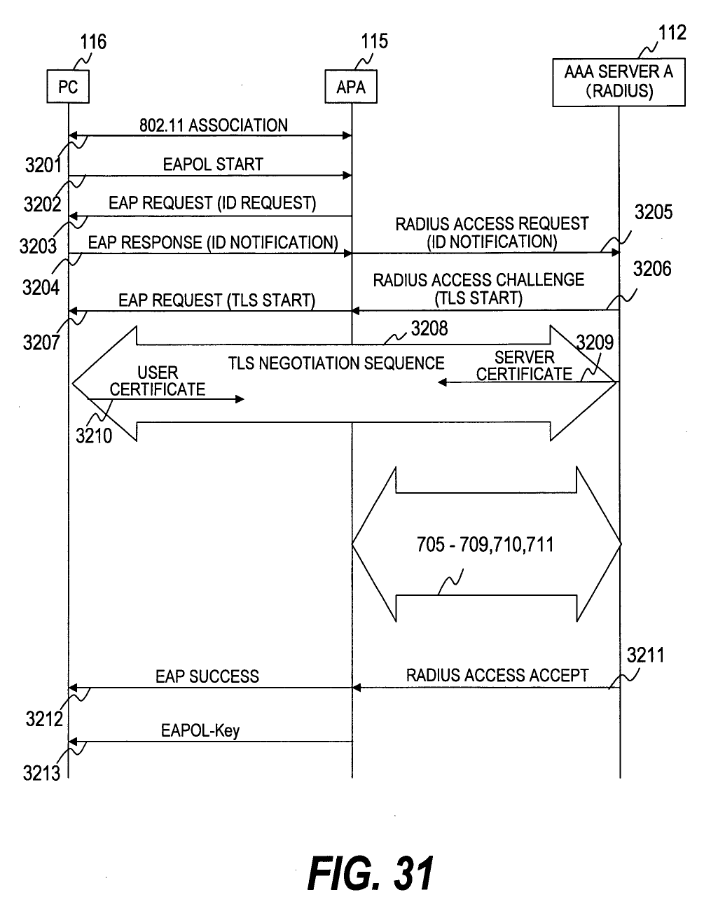

FIG. 31 is a sequence diagram of authentication processing in the computer system according to the tenth embodiment of this invention.

The AAA server A 112 issues a user certificate. The issued user certificate is stored in the user PC 116 or an external storage medium. A server certificate of the AAA server A 112 is also installed in the user PC 116 in advance.

First, the 802.11 association is executed between the user PC 116 and the AP A 115 (3201), thereby starting EAP over LAN (EAPOL) (3202).

Next, the AP A 115 requests an ID from the user PC 116 (3203). The user PC 116 then responds to the request by sending the ID to the AAA server A 112 via the AP A 115 (3204 and 3205).

The AAA server A 112 then notifies the user PC 116 via the AP A 115 of the start of TLS (3206 and 3207). A TLS negotiation sequence is thus started (3208).

Next, in the TLS negotiation sequence, the AAA server A 112 and the user PC 116 exchange their certificates with each other (3209 and 3210). In other words, the exchange involves the AAA server A 112 sending its server certificate to the user PC 116 and the user PC 116 sending its user certificate to the AAA server A 112. Based on the exchanged certificates, authentication is conducted.

Thereafter, Steps 705 to 709 and Steps 710 and 711 are executed. Steps 705 to 709 and Steps 710 and 711 are the same as those in the user access processing performed by the computer system of the first embodiment in the manner shown in FIG. 7, and the description will not be repeated.

Thereafter, the AAA server A 112 sends RADIUS access accept to the AP A 115 (3211). The AP A 115 then reacts by notifying the user PC 116 of EAP success (3212). According to EAP-TLS, an encryption key (EAPOL-Key) is created in the TLS negotiation sequence. The AP A 115 therefore sends the created encryption key to the user PC 116 (3213).

As described above, the computer system of the tenth embodiment uses electronic certificates in authentication.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising:
a first network connected to the Internet; and
a plurality of second networks connected to the Internet,
wherein the first network includes an access point which is connected to a first terminal device by radio or cable, a first communication device which is connected to the access point and controls communication of the first terminal device, a DHCP server which allocates an IP address to the first terminal device, and a first authentication server which authenticates the first terminal device,
wherein each of the plurality of second networks includes a second terminal device,
wherein the first authentication server is configured to:
identify which second network is associated with this first terminal device upon reception of an access request from the first terminal device; and
send, to the first communication device, access control information that is used to control communication of the second terminal device included in the identified second network, and
wherein the first communication device is configured to control communication of the first terminal device based on the access control information received from the first authentication server.

2. The computer system according to claim 1,
wherein the first network is a network provided by an service provider,
wherein the second plurality of networks are private networks built in companies, and
wherein the second network associated with the first terminal device is a second network to which the first terminal device is allowed to access.

3. The computer system according to claim 1,
wherein each of the plurality of second networks further includes a VPN server which provides VPN connection, and
wherein the first communication device is further configured to control communication of the first terminal device so as to allow connection between the first terminal device and the VPN server.

4. The computer system according to claim 1,
wherein each of the plurality of second networks further includes a second authentication server which authenticates the second terminal device, and
wherein the first authentication server is further configured to obtain access control information that is used to control communication of the second terminal device included in the identified second network from the second authentication server included in the identified second network.

5. The computer system according to claim 4,
wherein each of the plurality of second networks further includes a VPN server, which provides VPN connection, and
wherein the first authentication server is further configured to use the VPN connection provided by the VPN server to obtain access control information that is used to control communication of the second terminal device included in the identified second network from the second authentication server included in the identified second network.

6. The computer system according to claim 1,
wherein the first authentication server is further configured to:
identify a number of the first terminal devices which are controlled communication by the first communication device upon reception of an access request from the first terminal device; and
deny access from the first terminal device that has sent the access request when the identified number of the first terminal devices is larger than a predetermined threshold.

7. A computer system comprising:
a first network connected to the Internet;
a plurality of second networks connected to the Internet; and
a third network connected to the Internet,
wherein the first network includes an access point which is connected to a first terminal device by radio or cable, a first communication device which is connected to the access point and controls communication of the first terminal device, a DHCP server which allocates an IP address to the first terminal device, and a first authentication server which authenticates the first terminal device,
wherein each of the plurality of second networks includes a second terminal device,
wherein the third network includes a third authentication server,
wherein the first authentication server is configured to:
identify which second network is associated with this first terminal device upon reception of an access request from the first terminal device;
obtain access control information that is used to control communication of the second terminal device included in the identified second network from the third authentication server; and
send the obtained access control information to the first communication device, and
wherein the first communication device is configured to control communication of the first terminal device based on the access control information received from the first authentication server.

8. The computer system according to claim 7,
wherein the plurality of second networks are networks built within companies,
wherein the third network is a network provided by an service provider with which the companies have a contract,
wherein the first network is a network provided by an service provider which has a roaming contract with a service provider which provides the third network, and
wherein the second network associated with the first terminal device is a second network to which the first terminal device is allowed to access.

9. The computer system according to claim 7
wherein each of the plurality of second networks further includes a VPN server which provides VPN connection, and
wherein the first communication device is further configured to control communication of the first terminal device so as to allow connection between the first terminal device and the VPN server.

10. The computer system according to claim 7,
wherein each of the plurality of second networks further includes a second authentication server which authenticates the second terminal device, and
wherein the third authentication server is configured to store in advance access control information that is used to control communication of the second terminal device included in the second network.

11. The computer system according to claim 10,
wherein each of the plurality of second networks further includes a second authentication server which authenticates the second terminal device, and
wherein the third authentication server is further configured to obtain access control information that is used to control communication of the second terminal device included in the identified second network from the second authentication server included in the identified second network.

12. The computer system according to claim 7,
wherein the first authentication server is further configured to:
identify a number of the first terminal devices which are controlled communication by the first communication device upon reception of an access request from the first terminal device; and
deny access from the first terminal device that has sent the access request when the identified number of the first terminal devices is larger than a threshold.
